(19) United States
(12) Patent Application Publication
(10) Pub. No.: US 2026/0175576 A1
(43) Pub. Date: Jun. 25, 2026

(54) LIQUID DISCHARGING HEAD

(71) Applicant: SEIKO EPSON CORPORATION, Tokyo (JP)

(72) Inventors: Takeru HATO, MATSUMOTO-SHI (JP); Motoki TAKABE, SHIOJIRI-SHI (JP); Harunobu KOIKE, MATSUMOTO-SHI (JP)

(21) Appl. No.: 19/426,845

(22) Filed: Dec. 19, 2025

(30) Foreign Application Priority Data
Dec. 24, 2024 (JP) 2024-227121

(51) Int. Cl. B41J 2/14

(52) U.S. Cl. CPC B41J 2/14233; B41J 2002/14258

(57) ABSTRACT

A liquid discharging head includes a pressure chamber substrate that has a pressure chamber space forming a pressure chamber and a flow path space forming a flow path coupled to the pressure chamber, and a vibration plate, and a piezoelectric element that is formed on the vibration plate, in which the side walls of the pressure chamber substrate form a corner portion at a coupling location between the pressure chamber and the flow path, and when the pressure chamber is viewed in plan view from the vibration plate side, an active portion, which is a portion where the piezoelectric layer is interposed between a lower electrode and an upper electrode in the piezoelectric element, is a portion that overlaps a part of a first side wall that forms the corner portion and does not overlap the corner portion at an end portion in a longitudinal direction.

The present application is based on, and claims priority from JP Application Serial Number 2024-227121, filed December 24, 2024, the disclosure of which is hereby incorporated by reference herein in its entirety.

### BACKGROUND

### 1. Technical Field

The present disclosure relates to a liquid discharging head that discharges a liquid.

### 2. Related Art

As disclosed in JP-A-2013-158909, a technique of a liquid discharging head that discharges a liquid from a nozzle by applying pressure fluctuation to a liquid in a pressure chamber is known. The pressure fluctuation is generated by driving an actuator formed at a vibration plate forming one surface of the pressure chamber. As the actuator, a piezoelectric body in which electrodes are provided on both sides of the piezoelectric layer is used. When a voltage signal is applied between the electrodes that sandwich the piezoelectric layer, the piezoelectric body is deformed, and the deformation causes pressure fluctuation in the pressure chamber via the vibration plate.

The pressure chamber is formed by a method such as etching a silicon oxide plate material. However, it has been found that when the piezoelectric body is driven, a crack may occur in the side wall or the like that forms the pressure chamber.

### SUMMARY

According to an aspect of the present disclosure, there is provided a liquid discharging head. The liquid discharging head includes a pressure chamber substrate that has a pressure chamber space forming a pressure chamber and a flow path space forming a flow path coupled to the pressure chamber, the pressure chamber space and the flow path space being partitioned by side walls; a vibration plate that overlaps the pressure chamber substrate and covers the pressure chamber space, thereby forming one surface of the pressure chamber; and a piezoelectric element that is formed on the vibration plate, and in which a lower electrode, a piezoelectric layer, and an upper electrode are stacked in a thickness direction of the vibration plate. Here, the side walls of the pressure chamber substrate form a corner portion at a coupling location between the pressure chamber and the flow path, and, when the pressure chamber is viewed in plan view from a vibration plate side, an active portion, which is a portion where the piezoelectric layer is interposed between the lower electrode and the upper electrode in the piezoelectric element, overlaps, at an end portion in a first direction which is a longitudinal direction of the active portion, a part of a first side wall that forms the corner portion and partitions the pressure chamber space, and the active portion does not overlap the corner portion at the end portion.

According to another aspect of the present disclosure, there is provided a liquid discharging head that discharges a liquid from a nozzle by a pressure fluctuation of a pressure chamber. The liquid discharging head includes a pressure chamber substrate that has a pressure chamber space partitioned by a plurality of side walls; a vibration plate that overlaps the pressure chamber substrate and covers the pressure chamber space, thereby forming one surface of the pressure chamber; and a piezoelectric element that is formed on the vibration plate, and in which a lower electrode, a piezoelectric layer, and an upper electrode are stacked in a thickness direction of the vibration plate. Here, the pressure chamber space has at least one edge portion formed by two adjacent side walls among the plurality of side walls, and, when the pressure chamber is viewed in plan view from the vibration plate side, the active portion which is a portion in which the piezoelectric layer is interposed between the lower electrode and the upper electrode overlaps, in a longitudinal direction of the active portion, one of the two adjacent side walls, and the active portion does not overlap any of the edge portions formed by the side walls.

### BRIEF DESCRIPTION OF THE DRAWINGS

FIG. 1 is a perspective view for explaining a configuration of a printer including a liquid discharging head according to an embodiment.

FIG. 2 is a partially exploded perspective view of the liquid discharging head.

FIG. 3 is an explanatory diagram for explaining details of a pressure chamber and a flow path.

FIG. 4 is a schematic view illustrating a configuration of a main portion of the liquid discharging head taken along a cross section along a longitudinal direction of the pressure chamber.

FIG. 5 is a cross-sectional view taken along line V-V in FIG. 4.

FIG. 6 is an explanatory diagram illustrating the liquid discharging head viewed in plan view from a vibration plate side that is overlapped with one surface of the pressure chamber.

FIG. 7 is an explanatory diagram illustrating a positional relationship between a corner portion, which is provided at a coupling location between the pressure chamber and a flow path, and the active portion.

FIG. 8 is an explanatory diagram illustrating a comparison of differences in a positional relationship between the corner portion and the active portion.

FIG. 9 is an explanatory diagram illustrating an overlapping area of the active portion.

FIG. 10 is an explanatory diagram illustrating an overlapping angle of the active portion.

FIG. 11 is an explanatory diagram illustrating a magnitude relationship between a distance from a corner portion of the active portion in a first direction and a distance from a side wall in a second direction.

FIG. 12 is an explanatory diagram illustrating a configuration in which a lower electrode is used as a common electrode in plan view.

FIG. 13 is an explanatory diagram illustrating a configuration in which the lower electrode is used as the common electrode in a cross-sectional view.

FIG. 14 is an explanatory diagram illustrating a configuration including two corner portions at a coupling location between the pressure chamber and the flow path.

FIG. 15 is an explanatory diagram schematically illustrating an aspect of a protruding portion existing on a side wall of a pressure chamber, which is a feature of a second embodiment, together with a first region or a stress relaxation film.

FIG. 16 is a cross-sectional view taken along line XVI-XVI in FIG. 15.

FIG. 17 is a cross-sectional view of a piezoelectric element in which the piezoelectric element is broken along a longitudinal direction at a center of a lower electrode in a width direction, according to a third embodiment.

FIG. 18 is an explanatory diagram illustrating an aspect in which a protruding portion is an R portion and an elastic film constitutes a part of the structure of a pressure chamber.

FIG. 19 is an explanatory diagram illustrating a configuration of a liquid discharging head according to a fourth embodiment.

FIG. 20 is an explanatory diagram illustrating a configuration of a liquid discharging head according to a fifth embodiment.

FIG. 21 is an explanatory diagram illustrating another configuration of the liquid discharging head according to the fifth embodiment.

FIG. 22 is an explanatory diagram illustrating a configuration in which a pressure chamber and nozzles are coupled via a communication substrate.

### DESCRIPTION OF EMBODIMENTS

### A. First Embodiment:

Hereinafter, aspects for carrying out the present disclosure will be described with reference to the drawings. In embodiments described hereinafter, although various limitations are made as favorable specific examples of the present disclosure, the scope of the present disclosure is not limited to these aspects as long as there is no description particularly limiting the present disclosure. For example, in the following description, as an example of a liquid discharging head, an ink jet head that discharges ink and an ink jet printer (hereinafter, a printer) equipped with the ink jet head will be described. However, a liquid to be discharged is not limited to ink, and may be various liquids such as water, alcohol, oil, and medicines, or a suspension in which fine particles such as conductive particles such as pigments and metal powders are suspended in these liquids. In addition, in the present specification, sending out a liquid from a nozzle or the like to the outside is referred to as "discharging". The discharging includes various aspects in which a predetermined amount of liquid is ejected to the outside, such as ejection, jetting, spraying, discharge, and intermittent discharging, regardless of the type of liquid, the ejecting time, the number of times, and the like.

### A1. Configuration of Printer 1:

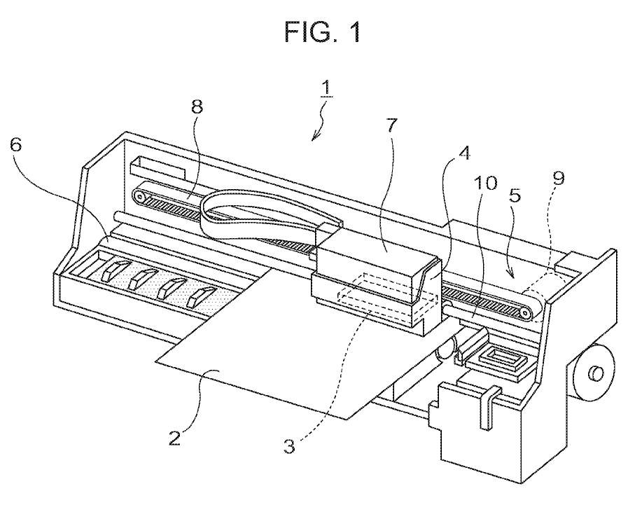

Before describing a liquid discharging head 3, a configuration of a printer 1 will be described with reference to FIG. 1. The printer 1 is a device that performs recording of an image or the like by ejecting a liquid ink onto a surface of a recording medium 2 such as recording paper. The printer 1 includes a liquid discharging head 3, a carriage 4 to which the liquid discharging head 3 is attached, a carriage moving mechanism 5 that moves the carriage 4 in a main scanning direction, a transport mechanism 6 that transfers the recording medium 2 in a sub-scanning direction, and the like. Here, the above-mentioned ink is a type of liquid and is stored in the ink cartridge 7 as a liquid supply source. The ink cartridge 7 is detachably mounted on the liquid discharging head 3. A configuration may be adopted in which the ink cartridge is disposed on the main body side of the printer, and the ink is supplied from the ink cartridge to a recording head through an ink supply tube.

The carriage moving mechanism 5 includes a timing belt 8. The timing belt 8 is driven by a pulse motor 9 such as a DC motor. Therefore, when the pulse motor 9 operates, the carriage 4 is guided by the guide rod 10 erected in the printer 1 and reciprocates in the main scanning direction (width direction of the recording medium 2).

### A2. Configuration of Liquid Discharging head:

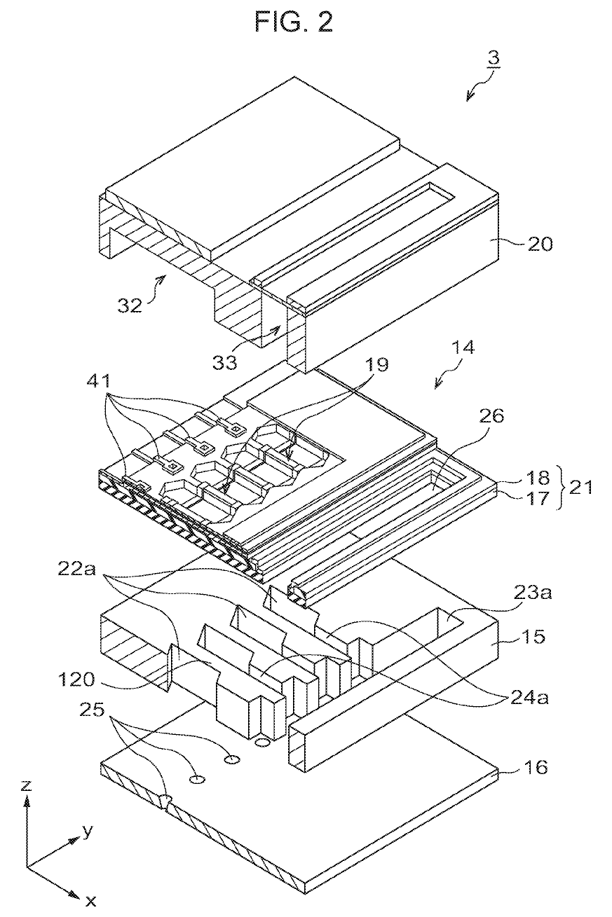

As illustrated in FIG. 2, the liquid discharging head 3 according to the first embodiment is configured by stacking, in order from the lower side, a nozzle plate 16 in which a plurality of nozzles are formed, a pressure chamber substrate 15 in which a pressure chamber space 22a to be described later and the like are formed, an actuator unit 14 having a vibration plate 21 at the bottom portion, and a sealing plate 20 for sealing the actuator unit 14, and the like. As illustrated in the drawing, the stacking direction is referred to as a z direction. In addition, a direction in which a plurality of nozzles 25 provided on the nozzle plate 16 are arranged is referred to as a y direction, and a direction orthogonal to the y direction is referred to as an x direction. In the present specification, the x direction may be referred to as a first direction, and the y direction may be referred to as a second direction. Each of the directions xyz is also appropriately described in other drawings.

The pressure chamber substrate 15 is, for example, a plate material made of a silicon single crystal substrate or the like. The pressure chamber substrate 15 is formed with a plurality of pressure chamber spaces 22a, a plurality of flow path spaces 24a, and a communication portion space 23a. The plurality of pressure chamber spaces 22a and the flow path spaces 24a are provided in parallel with the partition walls 120 interposed therebetween. Each of the pressure chamber spaces 22a and each of the flow path spaces 24a are coupled to each other. Furthermore, the plurality of flow path spaces 24a are commonly coupled to the communication portion space 23a.

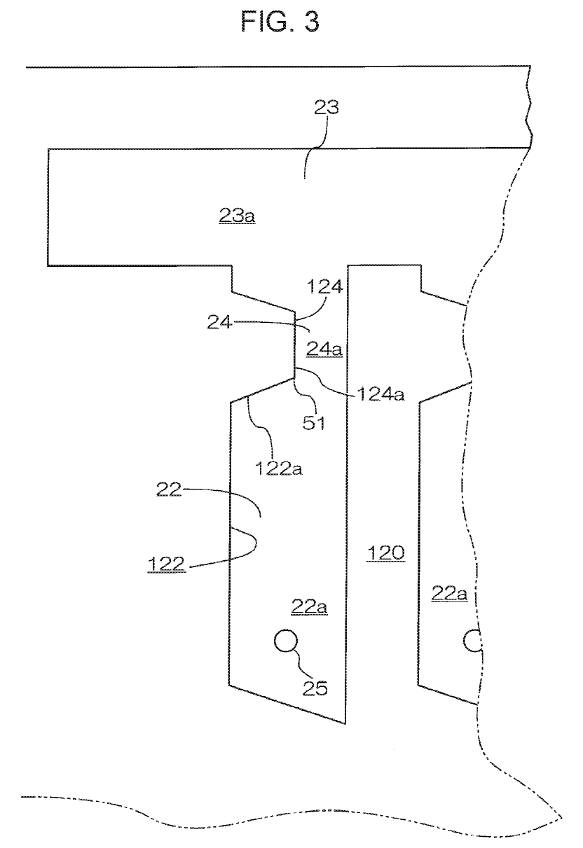

The partition walls 120 separate the plurality of pressure chamber spaces 22a and the flow path spaces 24a. The pressure chamber space 22a and the flow path space 24a are stacked with the nozzle plate 16 and the vibration plate 21 to form a pressure chamber 22 and a flow path 24, respectively. Similarly, the communication portion space 23a forms a communication portion 23. These relationships will be described in detail with reference to FIG. 3. As illustrated in the drawing, a partition wall 120 is present between the adjacent pressure chambers 22 and the flow paths 24, and side surfaces of the partition wall 120 in the x and y directions function as side walls for the pressure chamber 22 and the flow path 24. Among these side walls, the side wall that forms the pressure chamber 22 is referred to as a pressure chamber side wall 122, and the side wall that forms the flow path 24 is referred to as a flow path side wall 124.

The pressure chamber 22 is a pressure chamber space 22a surrounded by the pressure chamber side wall 122, and is surrounded at the bottom by the nozzle plate 16 and at the top by the vibration plate 21. Similarly, the flow path 24 is the flow path space 24a surrounded by the flow path side wall 124, and is surrounded by the nozzle plate 16 at the bottom and the vibration plate 21 at the top. The plurality of flow paths 24 are coupled to the communication portion 23, and when the liquid discharging head 3 is used, the spaces are filled with ink. In the following description, the pressure chamber 22 and the pressure chamber space 22a are referred to as the pressure chamber 22 when it is not necessary to particularly distinguish therebetween. The same applies to the flow path 24 and the communication portion 23.

In the present embodiment, the pressure chamber space 22a has a substantially trapezoidal shape when viewed in plan view in the z direction, and is surrounded by the four pressure chamber side walls 122. Among the four pressure chamber side walls 122, the side wall that forms the corner portion 51 together with the flow path side wall 124 on the flow path 24 side is referred to as a first pressure chamber side wall 122a as a side wall on the pressure chamber side, and may be distinguished from the other side walls. Similarly, the side wall on the flow path 24 side that forms the corner portion 51 together with the first pressure chamber side wall 122a may be referred to as a first flow path side wall 124a to be distinguished from the other side walls.

The partition wall 120 of the pressure chamber substrate 15 partitions the pressure chamber 22 as the pressure chamber side wall 122, partitions the flow path 24 as the flow path side wall 124, and the side walls form a corner portion 51 at a coupling location where the pressure chamber 22 and the flow path 24 are coupled. Therefore, the corner portion 51 is a section in which the two side walls protrude to the pressure chamber 22 side or the flow path 24 side, that is, to the outside when viewed from the partition wall 120. In this case, the first pressure chamber side wall 122a and the first flow path side wall 124a form an angle larger than 180 degrees. Naturally, the corner portion 51 is not limited to the one formed by the two adjacent side walls, and may be provided as a bent portion that is bent so that the side wall that couples the pressure chamber 22 and the flow path 24 protrudes to the outside. The corner portion 51 may be a pin corner sharpened to a manufacturing limit, or may have a predetermined chamfer or a curved surface (R). In any case, one (pressure chamber 22 side) of the corner portions 51 corresponds to the "side wall on the pressure chamber side" in the present specification.

The pressure chamber 22 is a long space in the first direction, and is provided to correspond to each of the nozzles 25 of the nozzle plate 16. That is, each pressure chamber 22 is formed at the same pitch as the formation pitch of the nozzle 25 along a nozzle row direction. The pressure chamber substrate 15 of the present embodiment is created by anisotropically etching a silicon single crystal substrate having a (110) plane orientation. Therefore, the upper opening (opening on the side opposite to the nozzle 25 side) of the pressure chamber 22 has a trapezoidal shape. An example of the dimensions of the pressure chamber 22 is as follows, but the present disclosure is not limited thereto. The dimension of the upper opening of the pressure chamber 22 in the first direction (x direction) is set to substantially 360 μm, the width of the upper opening of the pressure chamber 22, that is, the dimension in the second direction (y direction) is set to substantially 70 μm, and the height of the pressure chamber in the z direction, that is, the thickness of the pressure chamber substrate 15 is set to substantially 70 μm, respectively. The dimension of the upper opening of the pressure chamber 22 in the first direction (x direction) may be set to substantially 300 to 2000 μm, the dimension of the width of the upper opening of the pressure chamber 22 may be set to substantially 20 to 200 μm, and the height of the pressure chamber in the z direction may be set to substantially 30 to 200 μm.

As illustrated in FIG. 2, in the pressure chamber substrate 15, in an area separated from the flow path space 24a in the x direction, the communication portion space 23a penetrating the pressure chamber substrate 15 is formed along the direction in which the pressure chamber spaces 22a are provided. The communication portion 23 formed by the communication portion spaces 23a is a space portion common to each pressure chamber 22 and each flow path 24. The communication portion 23 and each pressure chamber 22 are communicated with each other through the flow path 24. The communication portion 23 communicates with a communication opening portion 26 of the vibration plate 21 and a liquid chamber empty portion 33 of the sealing plate 20, which will be described later, to configure a reservoir (common liquid chamber) which is a common ink chamber for each pressure chamber 22. The flow path space 24a is formed with a width narrower than that of the pressure chamber space 22a, and the flow path 24 serves as a flow path resistance with respect to the ink flowing from the communication portion 23 to the pressure chamber 22.

The pressure chamber substrate 15 and the nozzle plate 16 are bonded to each other via an adhesive, a heat welding film, or the like. In the present embodiment, the nozzles 25 are arranged side by side at a pitch (center distance between adjacent nozzles 25) corresponding to a dot formation density (for example, 300 dpi) on the nozzle plate 16. Each nozzle 25 communicates with the pressure chamber 22 at an end portion opposite to the flow path 24. The nozzle plate 16 is formed of, for example, glass ceramics, a silicon single crystal substrate, a polyimide-based photosensitive resin, stainless steel, or the like.

In the actuator unit 14 stacked on the pressure chamber substrate 15, a plurality of piezoelectric elements 19 corresponding to the respective pressure chambers 22 are provided on the upper surface of the vibration plate 21 configuring the upper surface of the pressure chamber 22 in the z direction, that is, on the side of the vibration plate 21 opposite to the pressure chamber 22. The vibration plate 21 includes an elastic film 17 on the pressure chamber substrate 15 side and an insulator film 18 formed at the elastic film 17. As the elastic film 17, for example, silicon dioxide (SiO₂) having a thickness of 300 to 2000 nm is suitably used. In addition, as the insulator film 18, for example, zirconium oxide (ZrOₓ) having a thickness of 30 to 600 nm is suitably used. A portion of the vibration plate 21 corresponding to the pressure chamber 22, that is, a portion that blocks the upper opening of the pressure chamber space 22a and partitions a part of the pressure chamber 22 functions as a displacement portion that is displaced in a direction away from or in a direction close to the nozzle 25 with the bending deformation of the piezoelectric element 19. A communication opening portion 26 communicating with the communication portion 23 is provided in a portion of the vibration plate 21 corresponding to the communication portion 23 of the pressure chamber substrate 15.

### A3. Configuration of Piezoelectric Element:

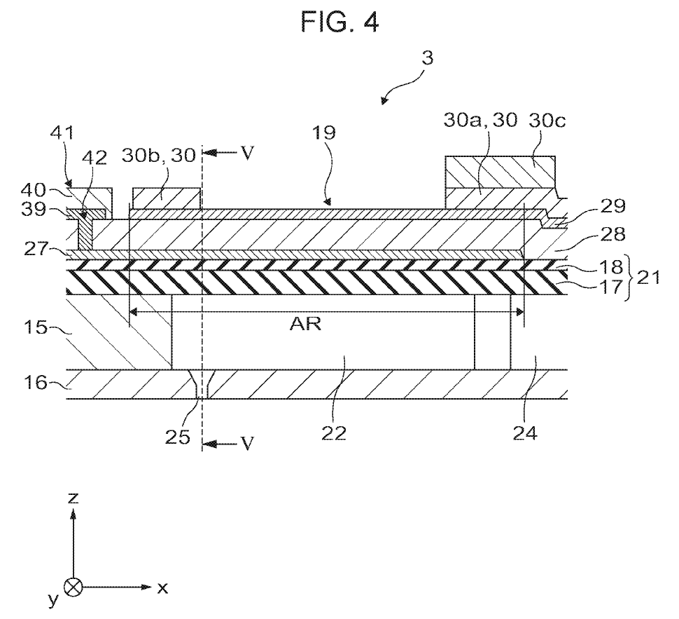

Next, the structure of the piezoelectric element 19 formed in the actuator unit 14 will be described with reference to FIGS. 4 to 6. In the present embodiment, the piezoelectric element 19 is formed by sequentially stacking a lower electrode 27, a piezoelectric layer 28, and an upper electrode 29 from the vibration plate 21 side by a film forming technique. As the upper electrode 29 and the lower electrode 27, various metals such as iridium (Ir), platinum (Pt), titanium (Ti), tungsten (W), tantalum (Ta), and molybdenum (Mo), and alloys thereof are used. In addition, as the piezoelectric layer 28, a ferroelectric piezoelectric material such as lead zirconate titanate (PZT) or a relaxor ferroelectric material to which a metal such as niobium, nickel, magnesium, bismuth, or yttrium is added is used.

An example of the thickness of each layer is illustrated below. The thickness of the upper electrode 29 can be set in the range of 15 to 100 nm, the thickness of the piezoelectric layer 28 (specifically, the thickness of the piezoelectric layer 28 in the portion interposed between the upper electrode 29 and the lower electrode 27) can be set in the range of 0.7 to 5 μm, and the thickness of the lower electrode 27 can be set in the range of 50 to 300 nm. Naturally, the appropriate dimensions may be set according to the materials used in each portion and the functions to be realized.

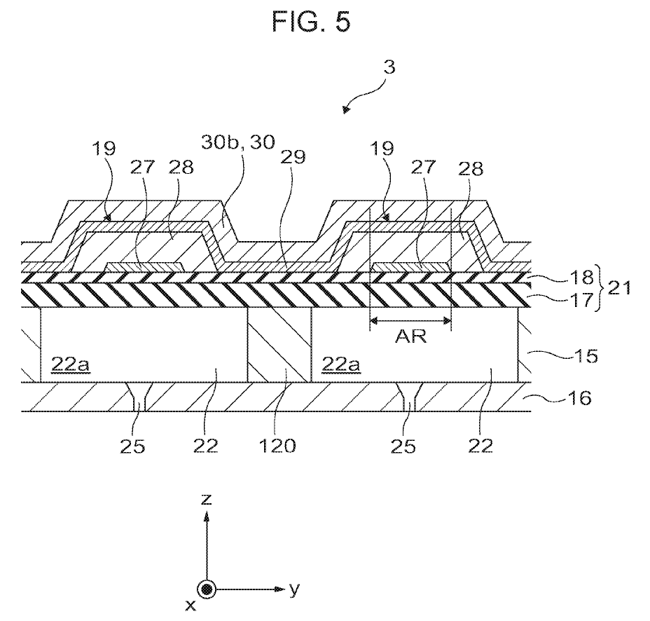

In the present embodiment, as illustrated in FIG. 5, the lower electrode 27 is provided independently for each individual pressure chamber 22, and the upper electrode 29 is continuously provided over the plurality of pressure chambers 22. Therefore, the lower electrode 27 is an individual electrode for each pressure chamber 22, and the upper electrode 29 is a common electrode common to each pressure chamber 22.

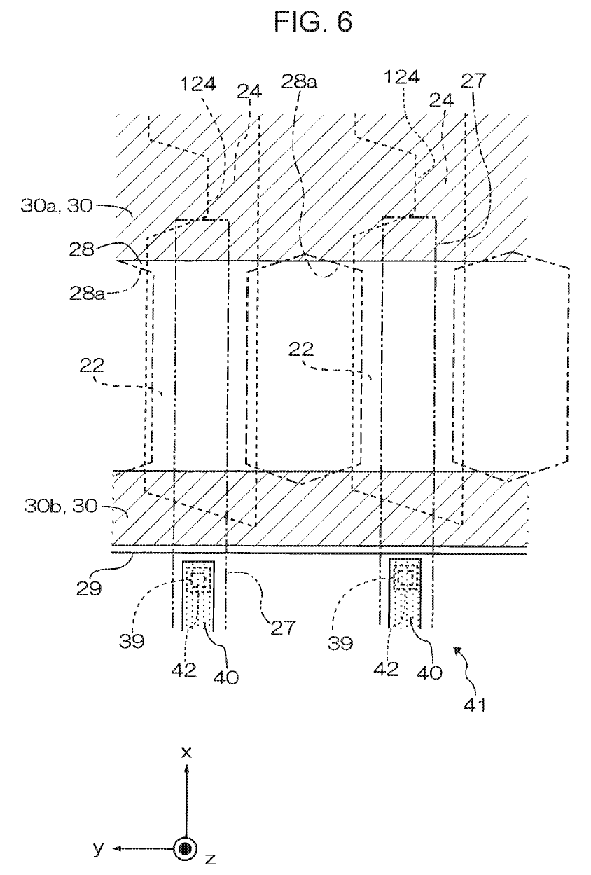

As illustrated in FIGS. 5 and 6, in the second direction (y direction), the width of the lower electrode 27 is formed to be narrower than the width of the pressure chamber 22 (specifically, the upper opening of the pressure chamber space 22a) and the width of the piezoelectric layer 28 (distance between the adjacent opening portions 28a (described later)) in the region corresponding to the pressure chamber 22. As illustrated in FIG. 6, in the first direction (x direction) which is the longitudinal direction of the pressure chamber 22, the lower electrode 27 has a portion in which an end portion on the flow path 24 side overlaps a part of the side wall 122 configuring the end portion of the pressure chamber 22 in plan view (viewed in the -z direction). In other words, the end portion of the lower electrode 27 on the flow path 24 side does not overlap the flow path 24. The overlapping state of the lower electrode 27 and the side wall 122 will be described in detail later. On the other hand, the end portion of the lower electrode 27 on the other side (−x direction) is extended to a lead electrode portion 41 as illustrated in FIG. 4.

The upper electrode 29 extends to the outside of a group of pressure chambers 22 both end portions of which are arranged side by side in the second direction (y direction). In addition, as illustrated in FIG. 4, the upper electrode 29 has one end portion extending beyond the end portion of the lower electrode 27 to the outside in the first direction (x direction) which is the longitudinal direction of the pressure chamber 22, and the other end portion (−x direction) extending beyond the end portion of the pressure chamber 22 to a region between the pressure chamber 22 and the lead electrode portion 41.

The piezoelectric layer 28 that is stacked by being interposed between the upper electrode 29 and the lower electrode 27 extends to the outside beyond both end portions of the pressure chamber 22 in the longitudinal direction, and is formed over the plurality of pressure chambers 22. A plurality of opening portions 28a in which the piezoelectric layer 28 is partially removed are formed in regions corresponding to spaces between the adjacent pressure chambers 22. That is, the plurality of opening portions 28a are formed along the second direction (y direction) which is the nozzle row direction at the same pitch as the formation pitch of the pressure chambers 22 (the formation pitch of the nozzles 25). In other words, the piezoelectric element 19 corresponding to one pressure chamber 22 is formed between the opening portion 28a and the opening portion 28a at the same pitch as the formation pitch of the pressure chambers 22. The width of the piezoelectric layer 28 in the nozzle row direction (distance between the adjacent opening portions 28a) on the pressure chamber space is formed to be narrower than the width of the pressure chamber 22 in the same direction and wider than the width of the lower electrode 27 in the same direction. Further, the length of the opening portion 28a in the longitudinal direction is formed to be shorter than the length of the pressure chamber 22 in the longitudinal direction (x direction) as illustrated in FIG. 6. That is, in the longitudinal direction, all the end portions on both sides of the opening portion 28a are positioned inside (the center side of the pressure chamber 22) than the end portions on both of the sides of the pressure chamber 22. In addition, the opening portions 28a of the present embodiment are formed in an elongated hexagonal shape along the longitudinal direction of the pressure chamber 22 in plan view. In addition, in the longitudinal direction of the pressure chamber 22, the piezoelectric layer 28 in the region separated from the opening portions 28a is continuously formed over the plurality of pressure chambers 22.

As illustrated in FIG. 5, the width (dimension in the y direction) of each portion of the piezoelectric element 19 is smaller in the order of the width of the upper electrode 29, the width of the pressure chamber 22, the width of the piezoelectric layer 28, and the width of the lower electrode 27 in the region corresponding to the pressure chamber 22. In the piezoelectric layer 28, a region interposed between the lower electrode 27 and the upper electrode 29 is distorted and causes displacement in the piezoelectric element 19 when a voltage is applied between the two electrodes. This range is referred to as an active portion AR. When the pressure chamber 22 is viewed in plan view from the vibration plate 21 side, the active portion AR is a range where the upper electrode 29 and the lower electrode 27 overlap in the first direction (x direction) and substantially coincides with the width of the lower electrode 27 in the second direction (y direction), as illustrated in FIGS. 4 and 5.

As described above, the opening portion 28a corresponds to a first region in which the piezoelectric layer 28 does not exist and the lower electrode 27 does not exist. Therefore, the opening portion 28a functions as an arm portion that facilitates the deformation of the vibration plate 21 when the active portion AR of the piezoelectric element 19 is driven by a drive signal, although the upper electrode 29 is present on the vibration plate 21.

A stress relaxation film 30 that is continuously formed over the plurality of pressure chambers 22 is stacked in an end portion region of the piezoelectric element 19 in the first direction (x direction) that is the longitudinal direction of the pressure chamber 22. The stress relaxation film 30 is provided at both end portions of the piezoelectric element 19, and when distinguishing both, the stress relaxation film 30 that is formed in the first direction (x direction), that is, in the end portion region on the flow path 24 side is referred to as a stress relaxation film 30a, and the stress relaxation film 30 that is formed in the end portion region on the opposite side is referred to as a stress relaxation film 30b. The stress relaxation films 30a and 30b are metal films (for example, NiCr) and are stacked on the upper electrode 29. In the present embodiment, the stress relaxation film 30 is continuously formed over the plurality of pressure chambers 22 and is formed at both sides of the opening portions 28a in the first direction (x direction).

The stress relaxation film 30a formed at the flow path 24 side extends from a region outside of the pressure chamber 22 and the flow path 24 to a region corresponding to the end portion of the opening portion 28a. In the present embodiment, as illustrated in FIG. 4, a restriction layer 30c that restricts the displacement of the piezoelectric element 19 is provided above the stress relaxation film 30a. The restriction layer 30c is a metal layer (for example, Au) and is called an Au weight because it restricts the displacement. The restriction layer 30c may not be provided. Alternatively, the restriction layer 30c may be directly formed at the upper electrode 29 instead of the stress relaxation film 30a of NiCr. On the other hand, the same stress relaxation film 30b is provided on the opposite side (nozzle 25 side) of the piezoelectric element 19 in the first direction (x direction). The stress relaxation film 30b extends from a region corresponding to the end portion on the other side of the opening portion 28a to a region between the pressure chamber 22 and the lead electrode portion 41 beyond the end portion of the pressure chamber 22. The restriction layer 30c that restricts the displacement of the piezoelectric element 19 may be provided above the stress relaxation film 30b.

As illustrated in FIG. 6, the stress relaxation film 30a has one side that overlaps an end portion including an opening portion 28a having a vertex of the elongated hexagonal shape in plan view, and overlaps an end portion including a boundary with the flow path 24 of the pressure chamber 22. Further, the stress relaxation film 30b has the other side that overlaps an end portion including a vertex on the other side of the opening portion 28a in plan view, and overlaps the end portion on the other side of the pressure chamber 22. When the stress relaxation film 30a overlaps the opening portion 28a in the first direction (x direction) which is the longitudinal direction of the pressure chamber 22, the rigidity of the piezoelectric element 19 in the region corresponding to the end portion of the pressure chamber 22 is increased without excessively suppressing the deformation of the piezoelectric element 19.

Electricity is supplied to the lower electrode 27 that is individually formed for each pressure chamber 22 via the lead electrode portion 41. As illustrated in FIGS. 4 and 6, the lead electrode portion 41 is formed at a position outside the end portion of the pressure chamber 22 on the nozzle 25 side and outside the stress relaxation film 30b. The lead electrode portion 41 is formed in a state where a through-hole 42 from the upper surface of the piezoelectric layer 28 to the lower electrode 27 penetrates the piezoelectric layer 28. A conductive upper electrode film 39 is formed to be slightly larger than the through-hole 42 in a region corresponding to the through-hole 42. The conductive upper electrode film 39 is individually patterned corresponding to the through-hole 42, and is conductive to the lower electrode 27 which is an individual electrode through the through hole 42. In addition, an individual metal layer 40 is patterned to correspond to the lower electrode 27 (through hole 42) on the conductive upper electrode film 39. With such a structure, the individual metal layer 40 is conductive to the lower electrode 27 via the conductive upper electrode film 39 formed in the region corresponding to the through-hole 42. The individual metal layer 40 (lead electrode portion 41) extends to a terminal region (not illustrated) and is electrically coupled to an individual electrode terminal of a wiring member. The lower electrode 27 is covered with the piezoelectric layer 28 except for a range facing the through-hole 42. As a result, leakage current from the lower electrode 27 is suppressed as much as possible, and it is possible to save the trouble of taking a special measure (for example, protection by a protective film such as aluminum oxide) for suppressing the leakage current. Naturally, the protective film may be provided.

As illustrated in FIG. 2, the actuator unit 14 is bonded to the pressure chamber substrate 15 in the lower side (−z direction), and is bonded to the sealing plate 20 having an accommodation space portion 32 that can accommodate the piezoelectric element 19 in the upper side (z direction). The sealing plate 20 is provided with the liquid chamber empty portion 33 at a position outside the accommodation space portion 32 in the x direction, that is, in a region corresponding to the communication opening portion 26 of the vibration plate 21 and the communication portion 23 of the pressure chamber substrate 15. The liquid chamber empty portion 33 penetrates the sealing plate 20 in the thickness direction and is provided along the pressure chamber 22 in the parallel direction (y direction). As described above, the liquid chamber empty portion 33 communicates with the communication opening portion 26 and the communication portion 23 in series to form a reservoir that is a common ink chamber for each pressure chamber 22. Although not illustrated, the sealing plate 20 is provided with a wiring opening portion that penetrates the sealing plate 20 in the thickness direction at a position corresponding to the terminal region of the actuator unit 14, in addition to the accommodation space portion 32 and the liquid chamber empty portion 33. The individual metal layer 40 and the stress relaxation film 30 of the terminal region are exposed in the wiring opening portion. The terminal of the wiring member (not illustrated) from a printer main body side is electrically coupled to the exposed portion of the stress relaxation film 30 or the metal layer 40.

In the liquid discharging head 3 having the above configuration, the flow path from the ink cartridge 7 to the liquid chamber empty portion (reservoir) 33, the flow path 24, the pressure chamber 22, and the nozzle 25 is filled with ink. Then, a drive voltage is applied to each of the piezoelectric elements 19 corresponding to the pressure chambers 22 at an appropriate timing by supplying the drive signal from the printer main body side. Since the drive voltage is applied between the lower electrode 27 and the upper electrode 29, an electric field corresponding to the potential difference between both of the electrodes is applied to the piezoelectric element 19, and the piezoelectric element 19 is deformed, and the active portion AR of the piezoelectric element 19 and the vibration plate 21 is displaced. As a result, pressure fluctuation occurs in the pressure chamber 22, and ink is discharged from the nozzle 25. By controlling the pressure fluctuation, an ink interface (meniscus) in the nozzle 25 is controlled, and an ink droplet having an appropriate size is ejected from the nozzle 25 toward the recording medium 2.

### A4. Disposition of Active Portion:

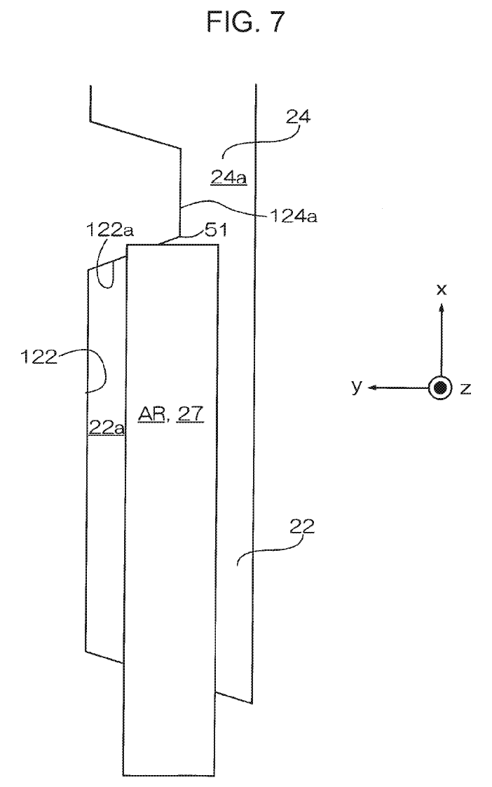

In the liquid discharging head 3 of the present embodiment, the active portion AR, here, the lower electrode 27 that determines the size of the active portion AR is disposed at a specific position with respect to the first pressure chamber side wall 122a of the side wall 122 that partitions the pressure chamber 22. This point will be described below in detail with reference to FIGS. 7 to 10. FIG. 7 shows the positional relationship between the corner portion 51 provided at the coupling location between the pressure chamber 22 and the flow path 24 and the active portion AR. In the drawing, the vibration plate 21 is not illustrated, and the pressure chamber 22 and the flow path 24 partitioned by the side walls 122 and 124 and the lower electrode 27 are drawn in a superimposed manner. In the present embodiment, as already described, the lower electrode 27 is the smallest in the lower electrode 27, the piezoelectric layer 28, and the upper electrode 29 which are stacked, and the lower electrode 27 and the active portion AR match each other at the end portion on the flow path 24 side. Therefore, in the following description, the disposition of the active portion AR will be described with reference to the lower electrode 27.

As illustrated in the drawing, when the pressure chamber 22 is viewed in plan view, the active portion AR, which is a portion in which the piezoelectric layer 28 is interposed between the lower electrode 27 and the upper electrode 29 in the piezoelectric element 19, here, the lower electrode 27 is disposed at a position which overlaps a part of the first pressure chamber side wall 122a, which is the side wall on the pressure chamber 22 side forming the corner portion 51 at the end portion in the first direction (x direction) which is the longitudinal direction of the piezoelectric element 19, and does not overlap with the corner portion 51. With such a disposition, the lower electrode 27 does not overlap the corner portion 51. Therefore, even when the drive voltage is applied to the piezoelectric element 19 and the piezoelectric element 19 is deformed together with the vibration plate 21, the stress from the lower electrode 27 is not applied to the corner portion 51. Therefore, it is possible to suppress the piezoelectric element 19 from being cracked or a crack from occurring at the section of the corner portion 51.

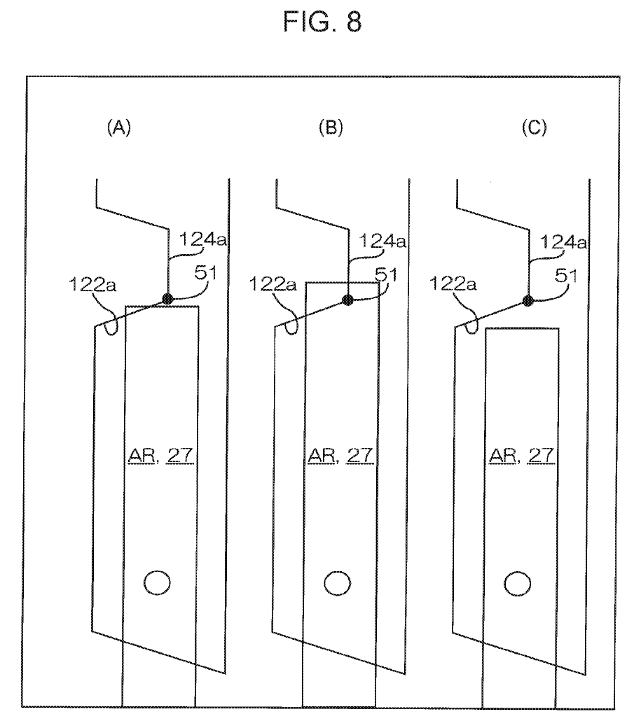

This point will be described in comparison with the other disposition of the piezoelectric element 19. FIG. 8 is an explanatory diagram illustrating a difference in a positional relationship between the corner portion 51 and the lower electrode 27 corresponding to the active portion AR. (A) of FIG. 8 shows the disposition of the present embodiment. In FIG. 8, the lower electrode 27 is illustrated by an outer line so that the positional relationship with the corner portion 51 is easily understood. The same applies to the examples of (B) and (C) of FIG. 8. (B) of FIG. 8 illustrates a disposition in which the end portion of the lower electrode 27, which is the active portion AR, on the flow path 24 side overlaps the corner portion 51. Further, (C) of FIG. 8 illustrates a disposition in which the end portion of the lower electrode 27, which is the active portion AR, on the flow path 24 side does not overlap any of the pressure chamber side walls 122 that configure the pressure chamber 22.

In the disposition illustrated in (B) of FIG. 8, the end portion of the lower electrode 27 corresponding to the active portion AR on the flow path 24 side overlaps the corner portion 51, and the reaction force accompanying the deformation of the vibration plate 21 by driving the piezoelectric element 19 is received from the corner portion 51. Therefore, the possibility of cracks, fractures, or the like occurring in the vibration plate 21 or the piezoelectric element 19 is increased. In addition, in the disposition illustrated in (C) of FIG. 8, the end portion of the lower electrode 27 corresponding to the active portion AR on the flow path 24 side does not overlap any section of the corner portion 51 or the pressure chamber side wall 122, and the deformation of the vibration plate 21 due to the driving of the piezoelectric element 19 is significantly different at the boundary between a section where the lower electrode 27 is present and a section where the lower electrode 27 is not present, and the reaction force is concentrated on the end portion of the lower electrode 27. Therefore, at the end portion of the lower electrode 27 on the flow path 24 side, the possibility of cracks, fractures, or the like occurring in the vibration plate 21 or the piezoelectric element 19 is increased. In the disposition (A) of the present embodiment, it is possible to suppress the possibility of cracks, fractures, or the like occurring in the vibration plate 21 or the piezoelectric element 19 as compared with the dispositions (B) and (C).

### A5. Other Features That Can Be Provided in Active Portion:

### 1. Another Feature 1:

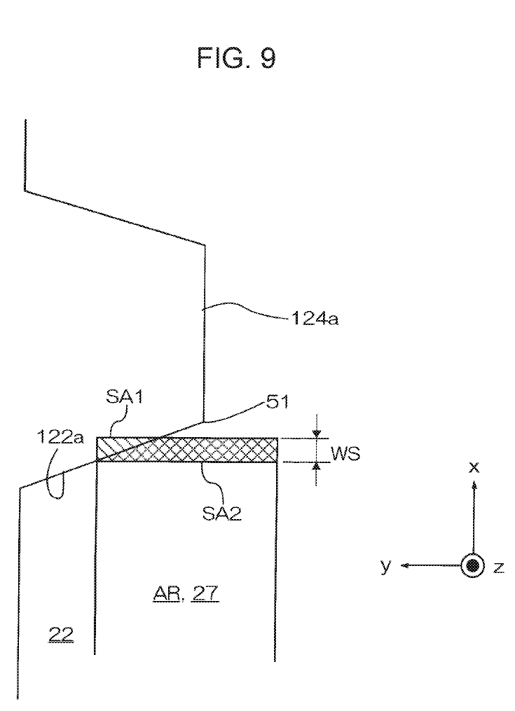

In the liquid discharging head 3 of the present embodiment, as illustrated in FIG. 9, when the pressure chamber 22 is viewed in plan view, the first area that is the area of the portion of the active portion AR, which overlaps the first pressure chamber side wall 122a (hereinafter, referred to as a superimposition region SA1), may be smaller than the second area that is the area of the portion of the active portion AR in which a first width WS in the first direction is the same as a width of the superimposition region SA1 and does not overlap the first pressure chamber side wall 122a (hereinafter, referred to as a non-superimposition region SA2). When the first area is smaller than the second area as described above, the stress applied to the first pressure chamber side wall 122a is reduced as compared with a case where the first area is larger than the second area, and the reaction force is also reduced as a result, so that it is possible to suppress the possibility of cracks, fractures, or the like occurring.

The area of the superimposition region SA1 in the embodiment is substantially 170 μm², the area of the non-superimposition region SA2 is substantially 920 μm², and the ratio of both is substantially 2:8. Naturally, this is only an example, but the ratio of both of the areas is preferably in the range of 1:9 to 4:6. Furthermore, the area of the superimposition region SA1 is preferably 30 μm² or more. When the area of the superimposition region SA1 is the above value or more, it is possible to avoid the concentration of stress on a small area, and as a result, it is possible to suppress the possibility of cracks, fractures, or the like occurring.

### 2 Another Feature 2:

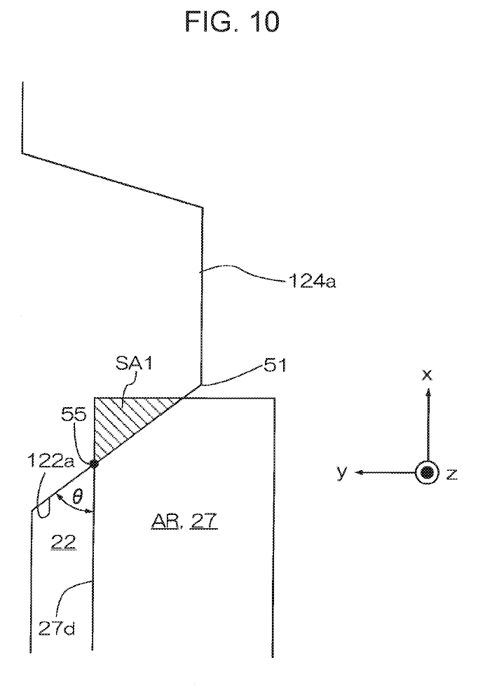

In the liquid discharging head 3 of the present embodiment, as illustrated in FIG. 10, when the pressure chamber 22 is viewed in plan view, an angle θ formed by one side 27d, which is an active portion AR side along the first direction and intersects the first pressure chamber side wall 122a, and the first pressure chamber side wall 122a may be 45 degrees or less. When the angle θ is 45 degrees or less, the drive voltage is applied to the piezoelectric element 19 and abrupt changes in the deflection are suppressed in the vicinity of where the end portion of the lower electrode 27 in the first direction (x direction) overlaps the first pressure chamber side wall 122a when the vibration plate 21 is displaced. In addition, in a case where θ is 45 degrees or less, the area of the superimposition region SA1 is also easily secured. When the angle θ is set to be 20 degrees or more, the piezoelectric element 19 is deformed in a convex shape toward the pressure chamber 22, and the vibration plate 21 is deformed in the direction of the pressure chamber 22, it is possible to alleviate the concentration of stress at the intersection 55 between the one side 27d of the lower electrode 27 on the second direction side and the first pressure chamber side wall 122a. In terms of alleviating the concentration of stress, the angle θ is preferably 20 degrees to 45 degrees, and more preferably 25 degrees to 32 degrees.

### 3 Another Feature 3:

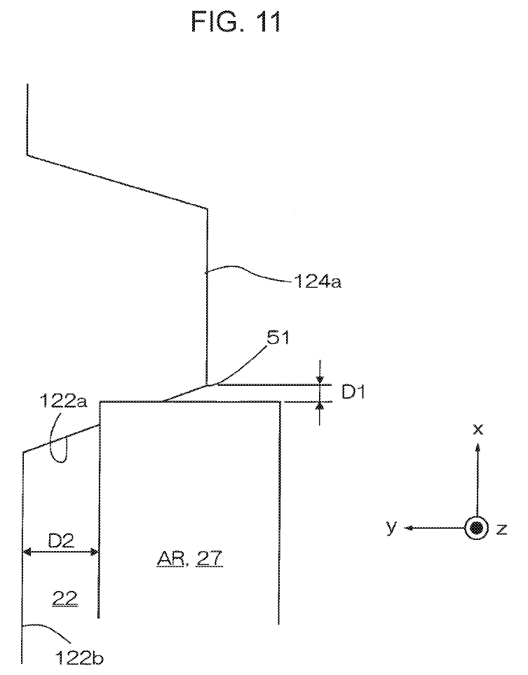

As illustrated in FIG. 11, in the liquid discharging head 3 of the present embodiment, the pressure chamber 22 has the second pressure chamber side wall 122b that is coupled to the first pressure chamber side wall 122a forming the corner portion 51 and partitions the pressure chamber 22 in the second direction (y direction). Here, when the pressure chamber 22 is viewed in plan view, a distance D2 between the side 27d of the lower electrode 27 in the second direction corresponding to the active portion AR in the second direction and the second pressure chamber side wall 122b may be larger than a distance D1 between the end portion of the lower electrode 27 corresponding to the active portion AR in the first direction and the corner portion 51.

With the above-described features, since D2 > D1, the displacement amount of the vibration plate 21 in the second direction can be increased, and as a result, the liquid discharging amount from the nozzle 25 can be increased.

### 4 Another Feature 4:

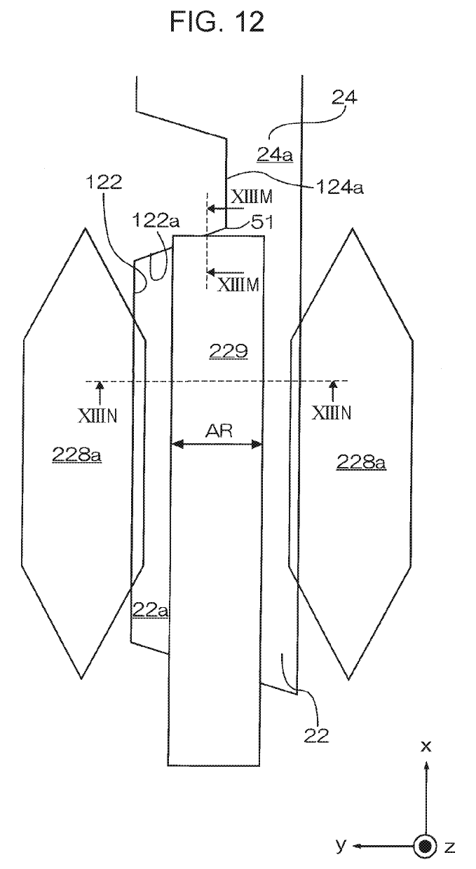

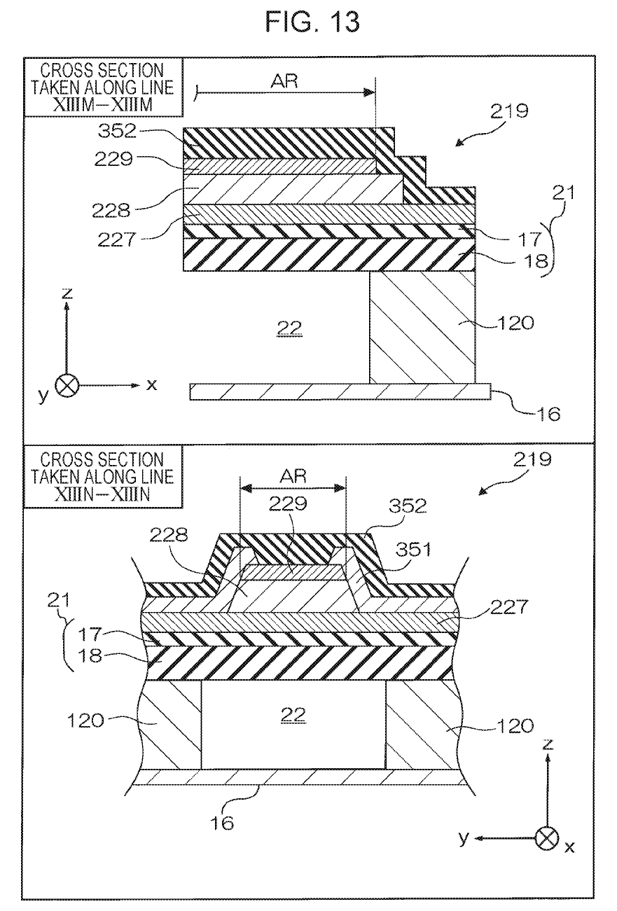

In the liquid discharging head 3 described above, the piezoelectric element 19 electrically couples the plurality of upper electrodes that are provided to correspond to each pressure chamber 22 to be used as the common electrode, but the lower electrode may be used as the common electrode. Whether the upper electrode or the lower electrode is used as the common electrode can be treated as a random selection feature. A configuration when a lower electrode 227 is used as the common electrode will be described with reference to FIG. 12 when the pressure chamber 22 is viewed in plan view from the vibration plate 21 side, and FIG. 13 which is a cross-sectional view taken along line XIIIM-XIIIM and a cross-sectional view taken along line XIIIN-XIIIN of FIG. 12. In the case where the lower electrode 227 is used as the common electrode, a configuration in which the lower electrodes 227 are continuously provided in the second direction (y direction) is used, and the upper electrode 229 is provided as an individual electrode. Therefore, as illustrated in FIG. 12, the active portion AR is a region corresponding to the upper electrode 229.

Other than the structure of a piezoelectric element 219, that is, the structure on the pressure chamber 22 side including the vibration plate 21 is the same as in the first embodiment described above, so that the same reference numerals are given to the same components, and the description thereof will be omitted. The lower electrode 227 is provided on the upper surface (surface in the z direction) of the vibration plate 21 as the common electrode, and a piezoelectric layer 228 and the upper electrode 229 are stacked on the lower electrode 227. The upper electrode 229 is an individual electrode, and the active portion AR corresponds to a region of the upper electrode 229 as described above. The piezoelectric element 219 is covered with a protective film 351 and an insulating film 352.

When the lower electrode 227 is used as the common electrode, similarly to the first embodiment, as illustrated in FIG. 12, an opening portion 228a that functions as an arm portion of vibration is formed between the piezoelectric elements 219 disposed in the y direction. In the opening portion 228a, the upper electrode 229 and the piezoelectric layer 228 are not present, and the lower electrode 227 that functions as the common electrode is present on the vibration plate 21, thereby facilitating deformation of the piezoelectric element 219.

As described above, either the upper electrode or the lower electrode may be the common electrode, but when the upper electrode 229 is the common electrode, a portion to which the stress is applied can be covered with the upper electrode 229, and the stress relaxation can be easily achieved. In addition, when the lower electrode 227 is used as the common electrode, the upper electrode 229 becomes the individual electrode, so that wiring to both the electrodes 227 and 229 is facilitated. On the other hand, when the upper electrode 29 is used as the common electrode, the piezoelectric layer 28 can be widely covered, and the piezoelectric layer 28 is easily prevented from being exposed to the outside. As a result, the reliability of the piezoelectric element 19 can be improved. When the upper electrode 29 is used as the common electrode, the pressure chamber side wall 122 and the like can be covered with the upper electrode 29 made of the same metal material, and it is easy to reduce the variation in the way the stress is applied. Therefore, it is difficult for a gap or the like to be generated in each portion, and it is possible to suppress the possibility that moisture enters the inside the piezoelectric element 19 from the gap. Any of the configurations may be adopted, depending on the usage form of the liquid discharging head 3.

### 5 Another Feature 5:

As already described, the presence or absence of the stress relaxation film 30, the presence or absence of the restriction layer 30c, the selection of the material when the stress relaxation film 30 or the restriction layer 30c is provided, and the like are randomly performed, and are not limited to the configuration of the above-described embodiment. When the stress relaxation film 30 is provided at a position covering, for example, the end portion of the active portion AR in the flow path direction, by driving the piezoelectric element 19, it is possible to obtain an action effect that the stress received from the first pressure chamber side wall 122a can be relaxed. Therefore, according to the specifications of the liquid discharging head 3, the required durability, and the like, the presence or absence of the stress relaxation film 30 or the restriction layer 30c, the position to which the stress relaxation film 30 or the restriction layer 30c is provided, the material to be used, and the like may be selected.

### 6 Another Feature 6:

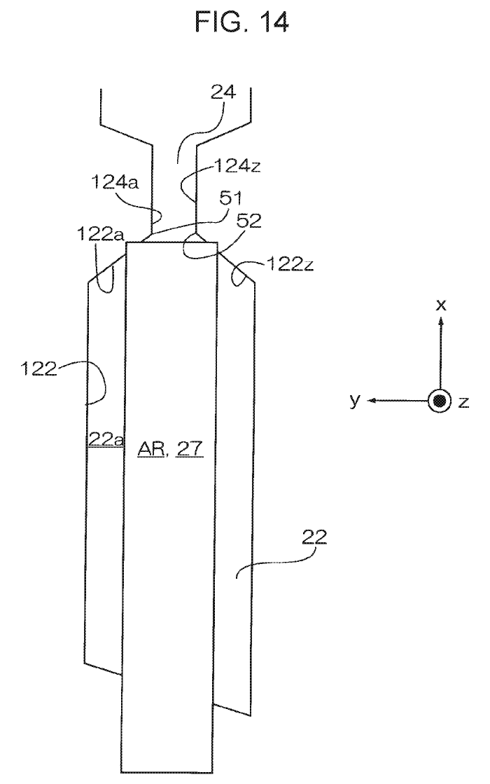

In the liquid discharging head 3 described above, the pressure chamber side wall 122 of the pressure chamber substrate 15 is described as forming one corner portion 51 at the coupling location between the pressure chamber 22 and the flow path 24. However, as illustrated in FIG. 14, a feature may be provided in which two corner portions 51 and 52 are included at the coupling location between the pressure chamber 22 and the flow path 24. In the example illustrated in the drawing, at the sections where the pressure chamber 22 is coupled to the flow path 24, the side walls on both sides protrude toward the center portion, and not only the first pressure chamber side wall 122a and the first flow path side wall 124a form the corner portion 51, but also a facing second pressure chamber side wall 122z and a second flow path side wall 124z form the corner portion 52. Also in this case, the lower electrode 27 corresponding to the active portion AR overlaps a part of the first pressure chamber side wall 122a and the second pressure chamber side wall 122z, which are the side walls on the pressure chamber 22 side forming the corner portions 51 and 52, and does not overlap the corner portions 51 and 52. Therefore, the same action effect as in the above-described embodiment is obtained.

Each of the above-described features 1 to 6 may be independently implemented, or two or more features may be combined and implemented. In addition, the same combinations can be appropriately made in the second embodiment and the like described below.

### B. Second Embodiment:

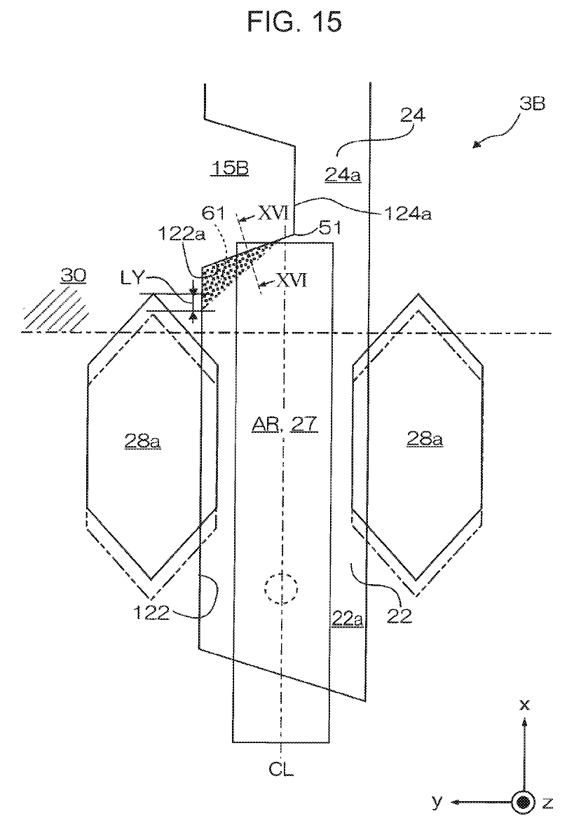

A liquid discharging head 3B of a second embodiment will be described. The liquid discharging head 3B of the second embodiment is incorporated in the printer 1 which is the same as in the first embodiment, and the configuration around the head is substantially the same except for the pressure chamber substrate 15B. As illustrated in FIG. 15, which is a plan view of the pressure chamber 22 from the vibration plate 21 side that covers the pressure chamber 22, the liquid discharging head 3B of the second embodiment includes a protruding portion 61 on the first pressure chamber side wall 122a that partitions the pressure chamber 22 on the flow path 24 side (x direction side). FIG. 15 corresponds to FIG. 12 in the first embodiment, and the disposition and shape of the opening portion 28a, the stress relaxation film 30, or the like corresponding to the first region are the same as in the first embodiment, as illustrated in the drawing.

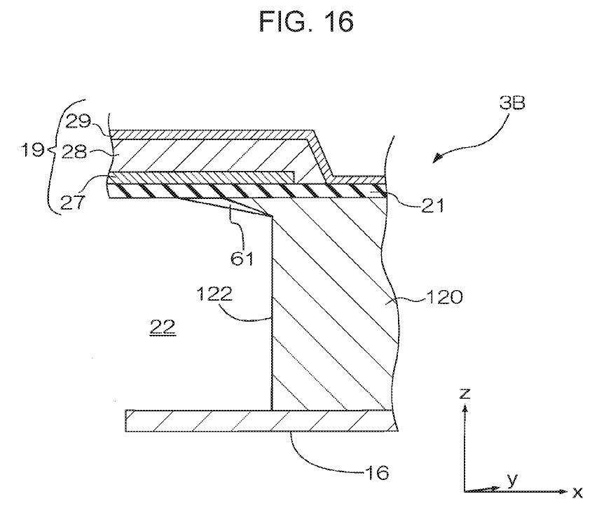

The shape of the protruding portion 61 will be described with reference to FIG. 16 which is a cross-sectional view taken along line XVI-XVI in FIG. 15. The cross section taken along line XVI-XVI is a cross section perpendicular to the first pressure chamber side wall 122a. As illustrated in the drawing, the protruding portion 61 is a portion protruding into the pressure chamber 22 along the surface of the vibration plate 21 at the upper end (z direction end portion) of the first pressure chamber side wall 122a, that is, the end portion that is in contact with the vibration plate 21. With regard to the protruding portion 61, when the pressure chamber substrate 15B is formed by etching a silicon single crystal substrate, the protruding portion 61 may be a part that is intentionally left, or may be formed as a remaining portion generated by the speed at which etching of the corner portion proceeds. By providing the protruding portion 61, the pressure applied to the vibration plate 21 or the piezoelectric layer 28 in the vicinity of the protruding portion 61 can be relaxed.

Moreover, in the present embodiment, when the pressure chamber 22 is viewed in plan view from the vibration plate 21 side, a part of the active portion, here, the end portion of the lower electrode 27 corresponding to the active portion AR on the flow path side (x direction side) overlaps at least a part of the protruding portion 61. In the piezoelectric element 19 of the second embodiment, a part of the end portion of the lower electrode 27 overlaps the protruding portion 61, but since the upper electrode 29 is provided as the common electrode, the piezoelectric layer 28 and the upper electrode 29 cover most of the protruding portion 61. Therefore, the stress applied from the lower electrode 27 corresponding to the active portion AR to the protruding portion 61 can be relaxed, and the occurrence of a situation in which the protruding portion 61 is cracked or fractured can be reduced. Further, since the upper electrode 29, which is the common electrode, widely covers the piezoelectric layer 28, the piezoelectric layer 28 is not exposed to the outside, and the influence of the external environment is unlikely to be received, so that high reliability, durability, and the like can be easily achieved.

In the illustrated embodiment, the thickness of the protruding portion 61 is linearly decreased as being separated from the pressure chamber side wall 122, but the present disclosure is not limited thereto. The thickness may also be a shape that is gradually decreased in a step shape. In this case, the tapering angle of each portion may be defined, for example, as an angle of a straight line connecting a position of the lowermost end where the protruding portion 61 is in contact with the first pressure chamber side wall 122a and a position of the uppermost end where the protruding portion 61 is in contact with the vibration plate 21. Alternatively, the angle of the inclined shape in the vicinity of the midpoint may represent the tapering angle. Naturally, the protruding portion 61 may be formed to have a uniform thickness.

Also in the second embodiment, as illustrated in FIG. 15, the opening portion 28a which is the first region is provided in which the piezoelectric layer 28 and the lower electrode 27 are not provided and the upper electrode 29 is provided. When the pressure chamber 22 is viewed in plan view, the opening portion 28a does not overlap the protruding portion 61. Therefore, when the piezoelectric element 19 is deformed, the opening portion 28a of the vibration plate 21 functions as an arm portion that is easily deformed, and the vibration of the vibration plate 21 is easily performed. In addition, the stress relaxation film 30 is provided above the lower electrode 27 corresponding to the active portion AR. When the pressure chamber 22 is viewed in plan view, the stress relaxation film 30 is provided from the outside of the active portion AR to a position overlapping the end portion of the active portion AR in the first direction (x direction) and the protruding portion 61. Therefore, the rigidity of the piezoelectric element 19 in the region corresponding to the end portion of the pressure chamber 22 in the first direction can be increased, and the stress applied to the protruding portion 61 can be relaxed.

As described above, the stress relaxation film 30 is provided from the outside to the inside of the pressure chamber 22 to at least a position covering the protruding portion 61, and the stress relaxation film 30 is also provided to overlap at least the tapered tip end portion of the opening portion 28a. Here, a configuration can be provided in which, with regard to the protruding portion 61 and the opening portion 28a which are covered together by the stress relaxation film 30, when the pressure chamber 22 is viewed in plan view from the vibration plate 21 side, as illustrated in FIG. 15, the protruding portion 61 can be configured not to overlap the tip of the opening portion 28a in the x direction. In this way, when the piezoelectric element 19 is driven and the vibration plate 21 vibrates, the opening portion 28a provided as the arm portion that is easily deformed is deformed, and thus it is possible to suppress a situation in which an excessive stress is applied to the protruding portion 61 and the protruding portion 61 is cracked or fractured.

As for this feature, that is, the configuration in which the protruding portion 61 does not overlap the tip end of the opening portion 28a in the x direction includes not only a positional relationship in which the two portions do not directly overlap each other in plan view as illustrated in FIG. 15, but also a positional relationship in which the two portions are separated from each other in the x direction but overlap each other when viewed in the y direction. In the illustrated example, in a range LY, the protruding portion 61 and the opening portion 28a are in a positional relationship of overlapping with each other when viewed in the y direction. The fact that the protruding portion 61 is provided at a position overlapping the tip end of the opening portion 28a in the y direction in the x direction means that, in other words, when the range of values that the protruding portion 61 can take on the x-axis is compared with the range of values that the opening portion 28a can take on the x-axis are compared in the x-y plane in which the protruding portion 61 and the opening portion 28a are viewed in plan view along the -z direction, it can be said that a range is present in which the values are the same.

The position of the opening portion 28a with respect to the protruding portion 61 may vary due to an error caused by manufacturing. Due to the variation, the distance between the tip end of the opening portion 28a and the protruding portion 61 may be shortened. When the distance between the opening portion 28a and the protruding portion 61 is reduced due to variations in manufacturing, the possibility of cracks or fractures occurring at the tip of the opening portion 28a or the protruding portion 61 is increased. At this time, for example, as illustrated by the two-dot chain line in FIG. 15, when the opening portion 28a is provided at a position that does not overlap the protruding portion 61 even when being viewed in the y direction, it is possible to further suppress the occurrence of cracks or fractures at the tip of the opening portion 28a or the protruding portion 61 even when the position of the opening portion 28a varies in the x direction or the y direction due to the manufacturing error.

### C. Third Embodiment:

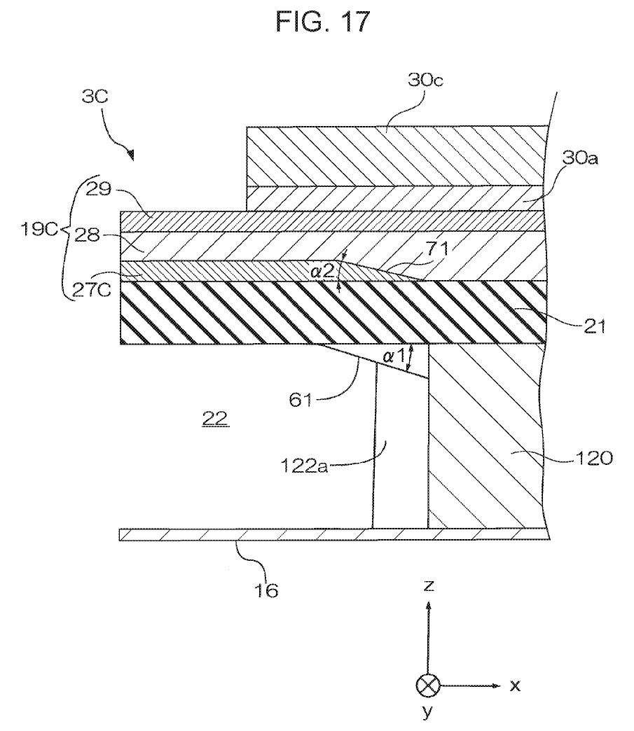

Next, a piezoelectric element 19C used for a liquid discharging head 3C of the third embodiment will be described. FIG. 17 is a cross-sectional view of the piezoelectric element 19C of the third embodiment in which the lower electrode 27 is broken along the longitudinal direction (x direction) at the center CL (refer to FIG. 15) in the width direction (y direction). The piezoelectric element 19C used in the liquid discharging head 3C of the third embodiment is different from the piezoelectric element 19 of the second embodiment in that the shape of the lower electrode 27C is different and the stress relaxation film 30a and the restriction layer 30c are provided above the protruding portion 61 (in the z direction) in the stacking direction. Other configurations are the same as in the second embodiment.

As illustrated in FIG. 17, the piezoelectric element 19C of the third embodiment is provided with the upper electrode 29 that widely covers the piezoelectric layer 28 as a common electrode, and a tapered portion 71 that has a thickness gradually decreasing at the end portion of the lower electrode 27C, prepared as an individual electrode, on the flow path 24 side (x direction side). As illustrated in the drawing, the piezoelectric layer 28 and the upper electrode 29 can widely cover the protruding portion 61 by using the upper electrode 29 as the common electrode. In addition, since the lower electrode 27C is provided as an individual electrode and the end portion of the lower electrode 27C on the flow path 24 side (x direction side) is the tapered portion 71, the stress generated in the piezoelectric element 19C can be gradually decreased toward the end portion of the piezoelectric element 19C in the longitudinal direction (x direction). As a result, it is possible to reduce the stress applied to the protruding portion 61, and it is possible to further reduce the risk of the protruding portion 61 cracking or fracturing.

Further, in the present embodiment, the protruding portion 61 has an inclined shape in which the width of the protrusion increases as the protruding portion 61 approaches the vibration plate 21, and the tapering angle (here, the inclined angle) α1 of the inclined shape of the protruding portion 61 is larger than an angle α2 formed by the tapered portion 71. In the embodiment, the inclined angle α1 is substantially 40 degrees, and the inclined angle α2 is substantially 30 degrees. In this case, as the thickness of the tapered portion 71 decreases, the thickness of the protruding portion 61 increases at a ratio larger than the ratio at which the thickness of the tapered portion 71 decreases. Therefore, the rigidity of the protruding portion 61 is relatively increased, and the risk of the occurrence of cracks or fractures can be further decreased. A random angle can be adopted as the angles α1 and α2, and it is also possible to adopt α1 ≤ α2. In addition, the protruding portion 61 and the tapered portion 71 are not limited to a shape in which the thickness smoothly decreases, and may have a shape in which the thickness decreases in a step shape. In this case, the tapering angle of each portion may be defined, for example, as an angle of a straight line connecting a position of the lowermost end where the protruding portion 61 is in contact with the first pressure chamber side wall 122a and a position of the uppermost end where the protruding portion 61 is in contact with the vibration plate 21. The same applies to the tapered portion 71. Alternatively, the angle of the inclined shape in the vicinity of the midpoint may represent the tapering angle. When the protruding portion 61 or the tapered portion 71 is formed by etching or the like, a shape that gradually increases or decreases in a step shape is easier to manufacture.

In the piezoelectric element 19C, in the stacking direction of the lower electrode 27C, the piezoelectric layer 28, and the upper electrode 29, the restriction layer 30c that is provided above the lower electrode 27C and restricts the displacement of the piezoelectric element 19C is provided, and when the pressure chamber 22 is viewed in plan view in the stacking direction, a part of the tip end portion of the lower electrode 27C overlaps the first pressure chamber side wall 122a and the restriction layer 30c. As a result, a part of the lower electrode 27C is interposed between the first pressure chamber side wall 122a, the protruding portion 61, and the restriction layer 30c, and the displacement of the protruding portion 61 when the piezoelectric element 19C is driven is suppressed. Therefore, it is possible to further reduce the risk of the protruding portion 61 cracking or fracturing.

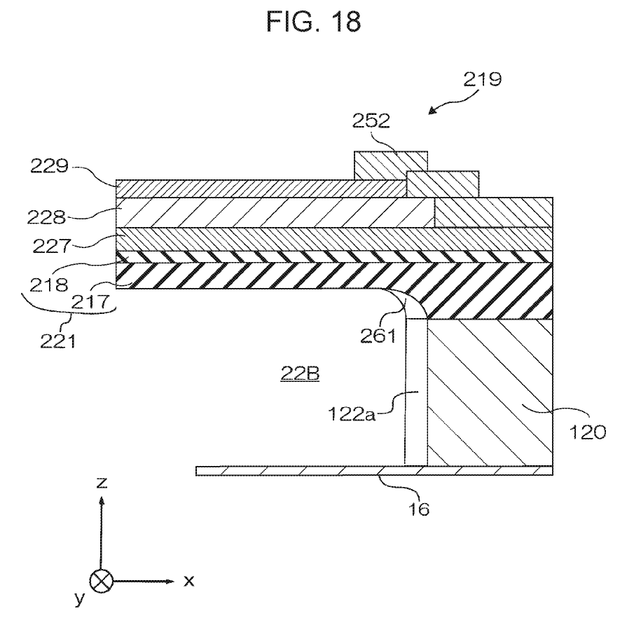

In the second and third embodiments, the upper electrode 29 is used as the common electrode, but as described in "Another Feature 4" of the first embodiment, the lower electrode side may be used as the common electrode. FIG. 18 is an explanatory diagram illustrating a configuration of the piezoelectric element 219 when the lower electrode 227 is used as a common electrode. In this example, a protective film 252 such as a metal film is provided so that the x-direction end portions of the upper electrode 229 and the piezoelectric layer 228 are not exposed. In this way, the end surface of each portion can be protected by the protective film 252. In the drawing, the protective film 252 is provided with a plurality of layers of individual protective films, but the protective film 252 may be formed as one protective film by sputtering or the like.

In the piezoelectric element 219 illustrated in FIG. 18, in an insulator film 218 and an elastic film 217 configuring the vibration plate 221, the elastic film 217 is formed of silicon dioxide (SiO₂), and has a thick shape in a portion that is in contact with the pressure chamber side wall 122 in the downward direction. A portion that connects the flat surface portion acting as the elastic film 217 and the pressure chamber side wall 122 (vertical surface) is formed as a pair with the elastic film 217 as an R portion 261 having a predetermined radius. Therefore, the abutting portion between the elastic film 217 and the pressure chamber side wall 122 has a recessed shape when viewed from the pressure chamber 22B side. The R portion 261 is an aspect of the protruding portion 61 in the above embodiment. Therefore, according to FIG. 15, when viewed in plan view from the vibration plate 221 side, the end portion of the active portion AR on the x direction side (in FIG. 18, the end portion of the upper electrode 229 on the x direction side) overlaps the R portion 261. As illustrated in FIG. 15, the end portion in the first direction, which is the longitudinal direction (x direction) of the active portion AR, overlaps with a part of the side wall 122a of the pressure chamber side that forms the corner portion 51 and does not overlap with the corner portion 51. This feature is also satisfied in the present embodiment.

In the above-described embodiment, the protruding portion 61 illustrated in FIGS. 16 and 17 has a cross section in a substantially triangular shape, that is, an inclined shape in which the width of the protrusion linearly increases as the protruding portion approaches the vibration plate 21. However, as illustrated in FIG. 18, a relationship in which the width of the protrusion increases as the protruding portion approaches the vibration plate 21 is satisfied even when the protruding portion 61 has a recessed portion shape including the curved R portion 261 on the pressure chamber side. As described above, the protruding portion 61 may be formed such that the width of the protrusion increases as the protrusion is made or the thickness of the protruding portion 61 is reduced, or may be formed to protrude with the same thickness. In addition, the protruding portion 61 may have a thickness that decreases in a step shape. The protruding portion may have an inclined shape in which the width (thickness) in the z direction at a first point at the end portion of the first pressure chamber side wall 122a on the vibration plate side is larger than the width (thickness) at a second point separated from the first pressure chamber side wall 122a from the first point. In this case, the width (thickness) of the protruding portion at another position separated from the first pressure chamber side wall 122a is not a problem. The fact that the width of the protrusion along the surface of the vibration plate 21 of the protruding portion 61 becomes larger as the protruding portion approaches the vibration plate includes a relationship that the envelope obtained when the width of the protrusion of the protruding portion 61 is measured at a predetermined pitch, that is, the average width of the protrusion for each predetermined pitch is larger as the protruding portion approaches the vibration plate, in addition to the configuration of the cross-sectional triangle as described above and the configuration of the R portion.

### D. Fourth Embodiment:

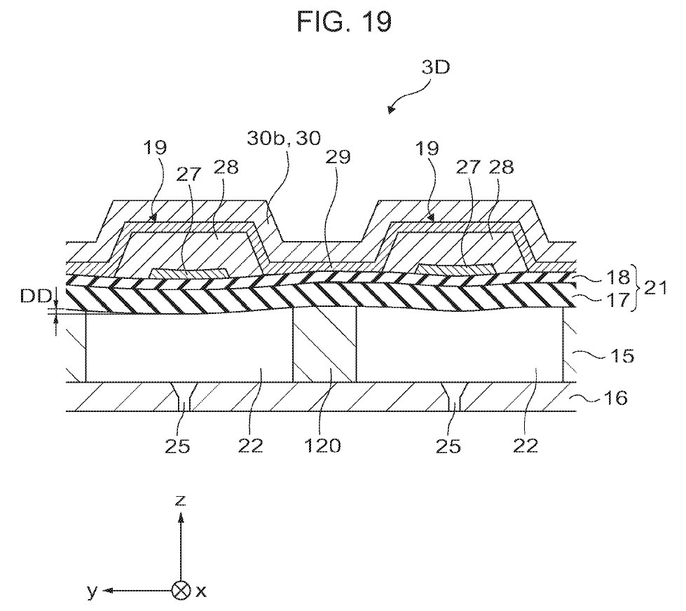

A liquid discharging head 3D of a fourth embodiment is illustrated in FIG. 19. FIG. 19 is a diagram corresponding to FIG. 5 of the first embodiment. The configuration of each portion of the liquid discharging head 3D of the fourth embodiment is the same as in the first embodiment. In a non-operating state in which a voltage is not applied to the piezoelectric element 19, the central portion of the vibration plate 21 has a shape swelled by a length DD in the downward direction (−z direction) as compared with the joint portion with the partition wall 120, that is, has a convex shape toward the pressure chamber 22 side.

Since the vibration plate 21 has a downward convex shape, the protruding portion 61 does not receive a force from the vibration plate 21 when the piezoelectric element 19 is not operated, and the reliability can be improved.

### E. Fifth Embodiment

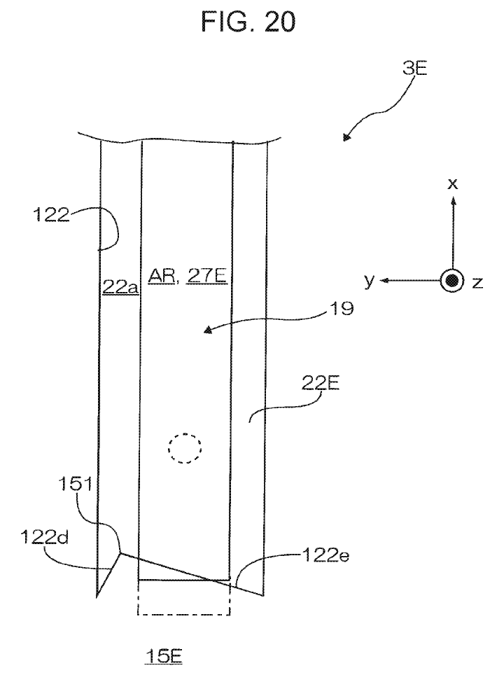

Next, a fifth embodiment will be described. As illustrated in FIG. 20, a liquid discharging head 3E of the fifth embodiment includes the same configuration as in the first embodiment except for the shape of a pressure chamber 22E in a pressure chamber substrate 15E. In this embodiment, the pressure chamber 22E includes a corner portion 151 on a rear end side (-x direction side) in the first direction, which is the longitudinal direction. In this example, the shape of the coupling location of the pressure chamber 22E with the flow path 24 may be the same as in the first embodiment, and the shape is not particularly limited.

In the present embodiment, a corner portion 151 is formed by a pressure chamber side wall 122d and a pressure chamber side wall 122e adjacent to the pressure chamber side wall 122d, at the rear end side of the pressure chamber 22E. On the other hand, a lower electrode 27E that defines the active portion AR overlaps one of the two adjacent side walls at the end portion of the rear end in the longitudinal direction, and does not overlap the corner portion 151. As a result, even when a drive signal is applied to the piezoelectric element 19 and the piezoelectric element 19 is deformed, the stress from the lower electrode 27E is not applied to the corner portion 151. Therefore, it is possible to suppress the piezoelectric element 19 from cracking or fracturing at the section of the corner portion 151.

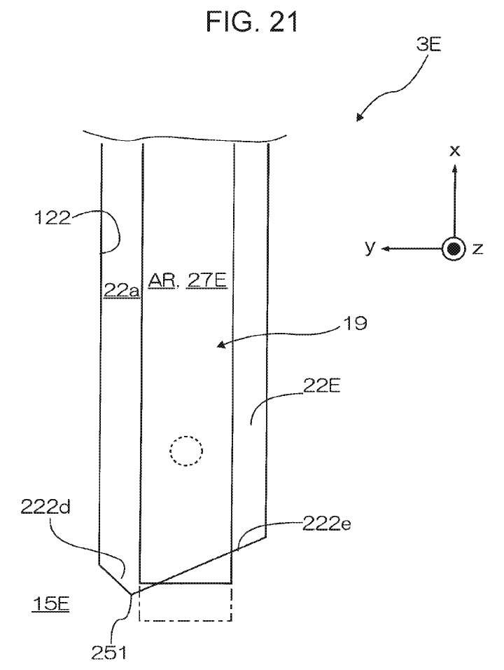

In FIG. 20, the corner portion 151 has a shape protruding toward the inside of the pressure chamber 22E, but as illustrated in FIG. 21, an edge portion 251 formed by two adjacent pressure chamber side walls 222d and 222e may have a concave shape when viewed from the pressure chamber 22E side. Regardless of the direction of the convex and concave shapes, a corner portion formed by two adjacent side walls among the plurality of side walls is widely referred to as the edge portion. Also in this case, the stress from the lower electrode 27E is not applied to the edge portion (corner portion) 251. Therefore, it is possible to suppress the piezoelectric element 19 from cracking or fracturing at the section of the edge portion 251.

The lower electrode 27E that defines the active portion AR may be provided to overlap one of the two adjacent side walls and not to overlap the corner portion 151 or the edge portion 251, and may be provided so that a part of the lower electrode 27E overlaps the side wall 122e on the rear end side in the longitudinal direction of the lower electrode 27E, or may be provided so that the entire lower electrode 27E in the width direction (y direction) overlaps the pressure chamber side wall 122e as illustrated by one-dot chain line in FIGS. 20 and 21.

### F. Other Embodiments:

1. The present disclosure can be implemented as a liquid discharging head described below. For example, the liquid discharging head includes a pressure chamber substrate that has a pressure chamber space forming a pressure chamber and a flow path space forming a flow path coupled to the pressure chamber, the pressure chamber space and the flow path space being partitioned by side walls; a vibration plate that overlaps the pressure chamber substrate and covers the pressure chamber space, thereby forming one surface of the pressure chamber; and a piezoelectric element that is formed on the vibration plate, and in which a lower electrode, a piezoelectric layer, and an upper electrode are stacked in a thickness direction of the vibration plate. Here, the side walls of the pressure chamber substrate form a corner portion at a coupling location between the pressure chamber and the flow path, and, when the pressure chamber is viewed in plan view from a vibration plate side, an active portion, which is a portion where the piezoelectric layer is interposed between the lower electrode and the upper electrode in the piezoelectric element, overlaps a part of the side wall on a pressure chamber side that forms the corner portion and does not overlap the corner portion at an end portion in a first direction which is a longitudinal direction of the active portion. In this way, since the active portion does not overlap the corner portion, even when the drive voltage is applied to the piezoelectric element and the piezoelectric element is deformed for each vibration plate, the stress from the active portion is not applied to the corner portion. Therefore, it is possible to suppress the piezoelectric element from cracking or fracturing at the section of the corner portion.

Here, the corner portion may be formed at a coupling location between the pressure chamber and the flow path as long as the side wall of the pressure chamber substrate is formed, and the formed corner portion may be, for example, a protrusion formed by the side wall of the pressure chamber itself, or may be a corner portion where the side wall of the pressure chamber substrate is in contact with the side wall forming the flow path at an angle of more than 180 degrees. The corner portion may be a so-called pin corner in which the adjacent side walls are in contact with each other, or may be provided with a degree of roundness (R) that occurs during manufacturing, an intentional rounded portion or a chamfered portion.

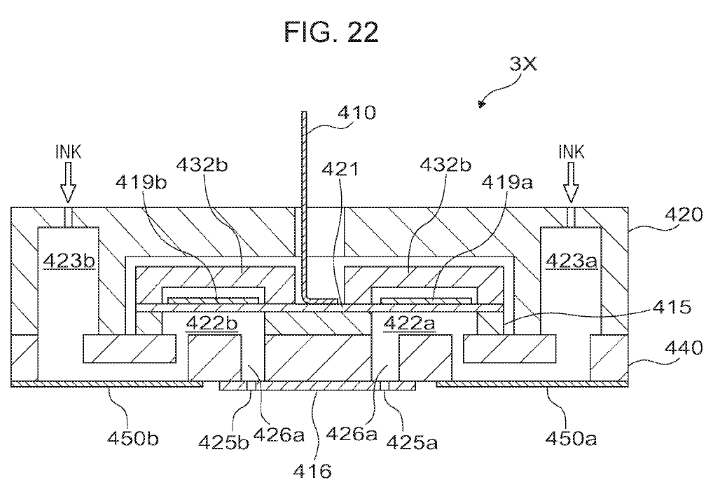

As described in the first to fifth embodiments, in the liquid discharging head, the pressure chamber space is partitioned by a plurality of side walls surrounding the pressure chamber space. The pressure chamber can be configured by covering one surface of the pressure chamber space with the vibration plate and providing the nozzle plate at a position facing the vibration plate as illustrated in FIG. 4 and the like. In this manner, when the piezoelectric element provided on the vibration plate is driven, the vibration plate is bent to change the pressure of the liquid in the pressure chamber, and the liquid is discharged from the nozzle. The pressure chamber is not limited to such a configuration, and the nozzle can be provided at a position from the pressure chamber via a communication path. An example of such a liquid discharging head is illustrated in FIG. 22.

A liquid discharging head 3X is configured by stacking a communication substrate 440, a pressure chamber substrate 415, and a sealing case 420 in this order from the bottom. A groove and an opening portion are formed and stacked on each substrate, thereby configuring the flow path and the pressure chamber. A nozzle plate 416 is provided at the bottom of the liquid discharging head 3X, and two rows of nozzles are provided. In the drawing, nozzles 425a and 425b are illustrated. Two pressure chambers 422a and 422b and two piezoelectric elements 419a and 419b are provided to correspond to the two nozzles 425a and 425b. A common vibration plate 421 is provided in the two pressure chambers 422a and 422b, and the piezoelectric elements 419a and 419b are provided on the vibration plate 421 to correspond to the respective pressure chambers 422a and 422b. The vibration plate 421 may be provided for each of the pressure chambers 422a and 422b. The piezoelectric elements 419a and 419b are accommodated in the sealing plates 432a and 432b, respectively. A signal line 410 is coupled to the piezoelectric elements 419a and 419b, so that a drive signal can be received from the outside.

Reservoirs 423a and 423b that are supplied with liquid, here, ink from an ink cartridge or the like and store the liquid are provided at both ends of the liquid discharging head 3X. Compliance substrates 450a and 450b are provided below the reservoirs 423a and 423b. The opening at the lower portion of the communication substrate 440 is closed by the compliance substrates 450a and 450b. Thus, a communication path is formed in the communication substrate 440, and the ink in the reservoirs 423a and 423b is supplied to the pressure chambers 422a and 422b via the communication path. Each of the pressure chambers 422a and 422b communicates with nozzle flow paths 426a and 426b formed in the communication substrate 440, and the nozzle flow paths 426a and 426b are sealed by the nozzle plate 416. Therefore, when the piezoelectric elements 419a and 419b are driven and the pressure in each of the pressure chambers 422a and 422b fluctuates, the pressure fluctuation also occurs in the nozzle flow paths 426a and 426b, and the pressure fluctuation causes ink droplets to be discharged from the nozzles 425a and 425b.

As described above, the configuration of the pressure chamber of the liquid discharging head is not limited to the configuration in the above-described embodiment, and various known configurations can be adopted. Here, all the ink flowing from the reservoirs 423a and 423b to the nozzle flow paths 426a and 426b is discharged from the nozzles 425a and 425b, but the ink may be supplied from the supply-side reservoir to the pressure chambers 422a and 422b and the nozzle flow paths 426a and 426b, and further collected in the collection reservoir. The collected ink may be circulated between the ink tank and the liquid discharging head by a pump or the like.

2. In the above configuration, when the pressure chamber is viewed in plan view and when an area where the active portion overlaps the side wall is set to a first area and an area of a portion not overlapping the side wall in the active portion having the same width (length) in the first direction as a width of the first area is set to a second area, the first area may be smaller than the second area. In this way, the stress applied to the first pressure chamber side wall 122a is reduced, and the reaction force is also reduced as a result, so that it is possible to suppress the possibility of cracks, fractures, or the like occurring.

3. In the above configuration, when the pressure chamber is viewed in plan view, an angle θ formed by one side of the active portion that is along the first direction and that intersects the side wall and the side wall may be 20 degrees or more and 45 degrees or less. In this way, when the vibration plate is displaced by the piezoelectric element, a sudden change in deflection can be suppressed near where the end portion of the active portion in the first direction overlaps the side wall that forms the corner portion. In addition, when the angle is 45 degrees or less, it is easy to secure the area of the region where the active portion overlaps the pressure chamber substrate on the side wall. When the angle is set to 20 degrees or more, when the piezoelectric element deforms the vibration plate in the pressure chamber direction, it is possible to alleviate the concentration of stress at the intersection between the side wall forming one side and the corner portion of the active portion on the second direction side. The angle is more preferably 25 degrees to 32 degrees.

4. In the configuration of 1 to 3, the liquid discharging head may further include a protruding portion that is formed toward an inside of the pressure chamber space with respect to a surface of the side wall as a reference at a coupling section where the side wall is in contact with the vibration plate, in which, when the pressure chamber is viewed in plan view, a part of the active portion overlaps the protruding portion. In this way, it is possible to alleviate the pressure applied to the vibration plate or the piezoelectric layer in the vicinity of the protruding portion. The protruding portion may include one or both of <1> a portion that is protruded from the side wall in contact with the vibration plate along the surface of the vibration plate at the coupling section, and <2> a portion in which a thickness of the vibration plate is increased over a predetermined range from a section in contact with the side wall at the coupling section toward a center portion of the pressure chamber space at the coupling section. When the protruding portion is formed in both <1> and <2>, the formation positions of both may be matched or may be misaligned. In addition, the portion in which the thickness on the vibration plate side is increased may be formed to be longer on the inner side of the pressure chamber space than the portion protruding to the side wall, and the two portions may be formed to be continuous.

When including the portion of <1>, the protruding portion may be formed by intentionally leaving the material when etching the material of the pressure chamber substrate, such as a silicon single crystal substrate, to form the pressure chamber, or may be formed as a remaining portion that is generated due to the speed at which etching of the corner portion progresses. When including the portion of <2>, the protruding portion may be formed by making the thickness of the vibration plate thicker than the other over a predetermined range from the section in contact with the side wall toward the center portion of the pressure chamber space, and for example, the thickness of the vibration plate may be made thicker as the protruding portion approaches the outer periphery of the pressure chamber space. The predetermined range increasing the thickness of the vibration plate may be a range of a constant distance from the outer periphery of the pressure chamber space toward the inside of the pressure chamber space, and may be a different range for each direction such as the first direction or the direction intersecting the first direction. In either case <1> or <2>, the method of manufacturing is not limited. Naturally, other configurations may be adopted, for example, a configuration in which the protruding portion forming substrate is disposed between the vibration plate and the pressure chamber substrate to form the protruding portion.

5. In the configurations of 1 to 4, the protruding portion may have an inclined shape in which a width of protrusion increases as the protruding portion approaches the vibration plate. In this way, the burden due to the self-weight of the protruding portion formed in the form of a cantilever beam from the side wall can be reduced. Naturally, the protruding portion may be formed to have the same thickness, or may be formed to have a thickness that gradually decreases in stages. Alternatively, the protruding portion may have an inclined shape in which the width of the protrusion at a first point at the end portion of the vibration plate of the side wall is larger than the width of the protrusion at a second point separated from the vibration plate from the first point.

6. In the configurations of 1 to 5, the vibration plate may have a first region, in which the piezoelectric layer is not provided and one of the upper electrode and the lower electrode is provided, in a second direction intersecting the first direction, and, when the pressure chamber is viewed in plan view, the first region may not overlap the protruding portion. In this way, when the piezoelectric element is deformed, the first region of the vibration plate functions as an arm portion that is easily deformed, and the vibration of the vibration plate is easily performed.

7. In the configurations of 1 to 6, the liquid discharging head may further include a stress relaxation film that is provided above the active portion in the stacking direction, and when the pressure chamber is viewed in plan view, the stress relaxation film may be provided from an outside of the active portion to a position overlapping the end portion of the active portion and the protruding portion. In this way, the rigidity of the piezoelectric element in the region corresponding to the end portion of the pressure chamber in the first direction can be increased, and the stress applied to this section, for example, the protruding portion can be relaxed. Various metal films such as a NiCr layer can be used as the stress relaxation film.

8. In the configurations of 1 to 7, the upper electrode is a common electrode provided in common to a plurality of piezoelectric elements, the lower electrode is an individual electrode provided individually for the plurality of piezoelectric elements, and when the pressure chamber is viewed in plan view, a tip end portion of the lower electrode overlaps the side wall and does not overlap the corner portion. In this way, the piezoelectric layer can be widely covered, and the piezoelectric layer is easily prevented from being exposed to the outside. As a result, the reliability of the piezoelectric element can be improved. When the upper electrode is used as the common electrode, the side wall of the pressure chamber or the like can be covered with the upper electrode made of the same metal material, and it is easy to reduce the variation in the way the stress is applied. Therefore, it is difficult for a gap or the like to be generated in each portion, and it is possible to suppress the possibility that moisture enters the inside of the piezoelectric element from the gap.

9. In the above configuration, the upper electrode may be a common electrode provided in common to a plurality of piezoelectric elements, the lower electrode may be an individual electrode provided individually for the plurality of piezoelectric elements, and an end portion in the first direction has a tapering portion in which a thickness decreases in the first direction, and when the pressure chamber is viewed in plan view, at least a part of the tapering portion may overlap the protruding portion. In this way, the stress generated in the piezoelectric element can be gradually decreased toward the end portion of the piezoelectric element in the first direction (longitudinal direction). As a result, it is possible to reduce the stress applied to the protruding portion, and it is possible to further reduce the risk of the protruding portion being cracked or fractured.

10. In the above configuration, the protruding portion may have an inclined shape in which a width of the protrusion increases as the protruding portion approaches the vibration plate, and an inclined angle of the inclined shape of the protruding portion may be larger than an angle formed by the tapered portion. In this way, as the thickness of the tapering portion decreases, the thickness of the protruding portion increases at a ratio larger than the ratio at which the thickness of the tapering portion decreases. Therefore, the rigidity of the protruding portion is relatively increased, and the risk of the occurrence of cracks or fractures can be further decreased.

11. In the above configuration, the pressure chamber may have a second side wall that is a side wall coupled to a first side wall which is the side wall on the pressure chamber side that forms the corner portion, and partitioning the pressure chamber in a second direction intersecting the first direction, and, when the pressure chamber is viewed in plan view, a distance between the active portion and the second side wall in the second direction may be larger than a distance between the active portion and the corner portion in the first direction. In this way, the displacement amount of the vibration plate in the second direction can be increased, and as a result, the function as the liquid discharging head, for example, the liquid discharging amount from the nozzle can be increased.

12. In the above configuration, the liquid discharging head further includes a restriction layer that is provided above the lower electrode in the stacking direction, and restricts displacement of the piezoelectric element, in which when the pressure chamber is viewed in plan view, the tip end portion of the lower electrode overlaps the side wall and the restriction layer. In this way, a part of the lower electrode is interposed between the side wall of the pressure chamber or the protruding portion forming the corner portion and the restriction layer, and the displacement of the protruding portion when the piezoelectric element is driven is suppressed. Therefore, it is possible to further reduce the risk of the protruding portion cracking or fracturing.

13. In the above configuration, the vibration plate may have a convex shape toward the pressure chamber when the piezoelectric body is not driven. Since the vibration plate has a downward convex shape, the protruding portion does not receive a force from the vibration plate when the piezoelectric element is not operated, and the reliability can be improved.

14. According to another aspect of the present disclosure, there is provided a liquid discharging head that discharges a liquid from a nozzle by a pressure fluctuation of a pressure chamber. The liquid discharging head includes a pressure chamber substrate that has a pressure chamber space partitioned by a plurality of side walls; a vibration plate that overlaps the pressure chamber substrate and covers the pressure chamber space, thereby forming one surface of the pressure chamber; and a piezoelectric element that is formed on the vibration plate, and in which a lower electrode, a piezoelectric layer, and an upper electrode are stacked in a thickness direction of the vibration plate. Here, the pressure chamber space may have at least one edge portion formed by two adjacent side walls among the plurality of side walls, and, when the pressure chamber is viewed in plan view from the vibration plate side, an active portion that is a portion in which the piezoelectric layer is interposed between the lower electrode and the upper electrode may overlap one of the two adjacent side walls at an end portion of the active portion in a longitudinal direction, and does not overlap the edge portion. In this way, even when the piezoelectric element is deformed, the stress from the active portion is not applied to the edge portion. Therefore, it is possible to suppress the piezoelectric element from cracking or fracturing at the section of the edge portion. The edge portion may have a convex shape or a concave shape when viewed from the pressure chamber side. When the pressure chamber includes a plurality of edge portions, the active portion may overlap one of the two adjacent side walls at the end portion of the active portion in the longitudinal direction and may not overlap the edge portion with respect to at least one of the edge portions.

The present disclosure is not limited to the above-described embodiments, and can be realized in various configurations without departing from the gist of the present disclosure. For example, technical features in the embodiments corresponding to technical features in respective aspects described in SUMMARY of the present disclosure can be replaced or combined as appropriate in order to solve some or all of the above-described problems or to achieve some or all of the above-described effects. Further, when the technical features are not described as essential in the present specification, the technical features can be appropriately deleted. For example, a part of the configuration realized by the hardware in the above embodiments can be realized by the software.

What is claimed is:

1. A liquid discharging head comprising:
a pressure chamber substrate that has a pressure chamber space forming a pressure chamber and a flow path space forming a flow path coupled to the pressure chamber, the pressure chamber space and the flow path space being partitioned by side walls;
a vibration plate that overlaps the pressure chamber substrate and covers the pressure chamber space, thereby forming one surface of the pressure chamber; and
a piezoelectric element that is formed on the vibration plate, and in which a lower electrode, a piezoelectric layer, and an upper electrode are stacked in a thickness direction of the vibration plate as a stacking direction, wherein
the side walls of the pressure chamber substrate form a corner portion at a coupling location between the pressure chamber and the flow path, and
when the pressure chamber is viewed in plan view from a vibration plate side, an active portion, which is a portion where the piezoelectric layer is interposed between the lower electrode and the upper electrode in the piezoelectric element, overlaps, at an end portion in a first direction which is a longitudinal direction of the active portion, a part of a first side wall that forms the corner portion and partitions the pressure chamber space, and the active portion does not overlap the corner portion at the end portion.

2. The liquid discharging head according to claim 1, wherein
when the pressure chamber is viewed in plan view and when an area where the active portion overlaps the first side wall is set to a first area and an area of a portion not overlapping the first side wall in the active portion having the same width in the first direction as a width of the first area is set to a second area, the first area is smaller than the second area.

3. The liquid discharging head according to claim 1, wherein
when the pressure chamber is viewed in plan view, an angle θ formed by one side of the active portion that is along the first direction and intersects the first side wall and the first side wall is 20 degrees or more and 45 degrees or less.

4. The liquid discharging head according to claim 1, further comprising:
a protruding portion that is formed toward an inside of the pressure chamber space with respect to a surface of the first side wall as a reference at a coupling section where the first side wall is in contact with the vibration plate, wherein
when the pressure chamber is viewed in plan view, a part of the active portion overlaps the protruding portion.

5. The liquid discharging head according to claim 4, wherein
the protruding portion has an inclined shape in which a width of protrusion increases as the protruding portion approaches the vibration plate.

6. The liquid discharging head according to claim 4, wherein
the vibration plate has a first region, in which the piezoelectric layer is not provided and one of the upper electrode and the lower electrode is provided, in a second direction intersecting the first direction, and
when the pressure chamber is viewed in plan view, the first region does not overlap the protruding portion.

7. The liquid discharging head according to claim 6, further comprising:
a stress relaxation film that is provided above the active portion in the stacking direction, wherein
when the pressure chamber is viewed in plan view, the stress relaxation film is provided from an outside of the active portion to a position overlapping the end portion of the active portion and the protruding portion.

8. The liquid discharging head according to claim 1, wherein
the upper electrode is a common electrode provided in common to a plurality of piezoelectric elements,
the lower electrode is an individual electrode provided individually for the plurality of piezoelectric elements, and
when the pressure chamber is viewed in plan view, a tip end portion of the lower electrode overlaps the side wall and does not overlap the corner portion.

9. The liquid discharging head according to claim 4, wherein
the upper electrode is a common electrode provided in common to a plurality of piezoelectric elements,
the lower electrode is an individual electrode provided individually for the plurality of piezoelectric elements, and an end portion in the first direction has a tapering portion in which a thickness decreases in the first direction, and
when the pressure chamber is viewed in plan view, at least a part of the tapering portion overlaps the protruding portion.

10. The liquid discharging head according to claim 9, wherein
the protruding portion has an inclined shape in which a width of protrusion increases as the protruding portion approaches the vibration plate, and
an inclined angle of the inclined shape of the protruding portion is larger than a tapering angle formed by the tapering portion.

11. The liquid discharging head according to claim 8, wherein
the pressure chamber has a second side wall that is coupled to the first side wall and that partitions the pressure chamber in a second direction intersecting the first direction, and
when the pressure chamber is viewed in plan view, a distance between the active portion and the second side wall in the second direction is larger than a distance between the active portion and the corner portion in the first direction.

12. The liquid discharging head according to claim 8, further comprising:
a restriction layer that is provided above the lower electrode in the stacking direction, and restricts displacement of the piezoelectric element, wherein
when the pressure chamber is viewed in plan view, the tip end portion of the lower electrode overlaps the side wall and the restriction layer.

13. The liquid discharging head according to claim 1, wherein
the vibration plate has a convex shape toward the pressure chamber when the piezoelectric element is not driven.

14. A liquid discharging head that discharges a liquid from a nozzle by a pressure fluctuation of a pressure chamber, the liquid discharging head comprising:
a pressure chamber substrate that has a pressure chamber space partitioned by a plurality of side walls;
a vibration plate that overlaps the pressure chamber substrate and covers the pressure chamber space, thereby forming one surface of the pressure chamber; and
a piezoelectric element that is formed on the vibration plate, and in which a lower electrode, a piezoelectric layer, and an upper electrode are stacked in a thickness direction of the vibration plate as a stacking direction, wherein
the pressure chamber space has at least one edge portion formed by two adjacent side walls among the plurality of side walls, and
when the pressure chamber is viewed in plan view from the vibration plate side, an active portion, which is a portion in which the piezoelectric layer is interposed between the lower electrode and the upper electrode, overlaps, in a longitudinal direction of the active portion, one of the two adjacent side walls, and the active portion does not overlap any of the edge portions formed by the side walls.
